(19) United States
(12) Patent Application Publication
(10) Pub. No.: US 2009/0276368 A1
(43) Pub. Date: Nov. 5, 2009

(54) SYSTEMS AND METHODS FOR PROVIDING PERSONALIZED RECOMMENDATIONS OF PRODUCTS AND SERVICES BASED ON EXPLICIT AND IMPLICIT USER DATA AND FEEDBACK

(75) Inventors: Francisco J. Martin, Corvallis, OR (US); Jim Shur, Barcelona (ES); Darren Brown, Corvallis, OR (US); Adam Ashenfelter, Corvallis, OR (US); Ken Baldwin, Corvallis, OR (US); Steve Taylor, Corvallis, OR (US)

Correspondence Address: Stolowitz Ford Cowger LLP, 621 SW Morrison St, Suite 600, Portland, OR, 97205, US

(73) Assignee: STRANDS, INC., Corvallis, OR (US)

(21) Appl. No.: 12/431,714

(22) Filed: Apr. 28, 2009

Related U.S. Application Data
(60) Provisional application No. 61/048,537, filed on Apr. 28, 2008.

(51) Int. Cl. G06Q 40/00

(52) U.S. Cl. 705/36 R; 705/35

(57) ABSTRACT

The present describes systems and methods to support personal financial management by recommending financial products and services responsive to a user's particular financial health or situation based on explicit and implicit user data and feedback.

### RELATED APPLICATIONS

This application claims priority to U.S. provisional patent application No. 61/048,537, filed May 28, 2008, titled SYSTEMS AND METHOD FOR PROVIDING PERSONALIZED RECOMMENDATIONS OF FINANCIAL PRODUCTS AND SERVICES, which we incorporate here by reference.

### COPYRIGHT NOTICE

© 2008 Strands, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever provided under at least 37 CFR § 1.71(d).

### TECHNICAL FIELD

The present describes systems and methods to support personal financial management. More particularly, the present describes systems and methods for providing personalized recommendations of financial products and services.

### BACKGROUND

The onset of web-based banking and web-based financial record keeping has brought about a paradigm shift in the way most users think about managing their personal finances. No longer is there a need to “run to the bank” to make deposits, withdrawals, or check account balances. Most users now have on-line access to their financial records, including savings and checking accounts, retirement plan accounts, loans, and the like. This access, however, is usually tied to the financial institution holding the user's accounts and not to the user, holder, or owner of the account. For example, the financial institution that holds a user's savings and checking accounts allows the user access to those accounts through its website. That financial institution, however, cannot usually provide the user access to other his accounts when those accounts are held by one or more other financial institutions.

For security purposes, each financial institution requires the user have a login name and password. These login names and passwords are oftentimes different for each institution as is usually recommended by security experts. While these separate login names and passwords help maintain the user's financial records secure, they can be easily forgotten or lost requiring resetting and ultimately, access delay. More importantly, however, it is difficult for the user to track his financial health if he cannot view and analyze his accounts simultaneously through a single website or portal in a fast, convenient form that is always current, but not labor intensive to maintain and access. An improved system should aggregate data automatically across the person's multiple financial accounts.

Moreover, the user will not usually have a complete view of the wealth of financial products and services offered by the various financial institutions. These products and services are complex and often difficult to understand. Being able to compare the characteristics and descriptions of different products and services simultaneously would allow the user efficient and educated choices regarding those products and services. An improved system should provide personalized, intelligent recommendations of financial products and services based on the user's current financial health, history, trends, preferences, and other like information

A need remains, therefore, for improved systems and methods for recommending financial products and services. Additional aspects and advantages of this invention will be apparent from the following detailed description of preferred embodiments, which proceeds with reference to the accompanying drawings.

### BRIEF DRAWINGS DESCRIPTION

FIG. 1 is a screen shot of an embodiment of a user interface.

FIGS. 2A-C are screen shots of an embodiment of an Accounts widget.

FIGS. 3A-C are screen shots of an embodiment of a Recommendations widget.

FIG. 4 is a screen shot of an embodiment of a Financial Health widget.

FIGS. 5A-B are screen shots of an embodiment of a Transactions widget.

FIGS. 6A-B are screen shots of an embodiment of an Alerts widget.

FIG. 7 is a screen shot of an embodiment of a Help widget.

FIG. 8 is a block diagram of components associated with an embodiment of a recommender system and method.

FIG. 9 is a block diagram of an embodiment of a system for implementing the recommender system and method shown in FIG. 8.

FIGS. 10A-F is a block diagram of an embodiment of a system and method for hierarchical mining of transactional data.

FIG. 11 is a simplified flow diagram of an embodiment of assigning predetermined categories to financial transactions.

FIG. 12 is a simplified flow diagram of an embodiment of an iterative process for inferring various user profile data from mining financial transactions.

FIG. 13 is a block diagram of an embodiment of a recommender engine shown in FIG. 8.

FIG. 14 is a block diagram of an embodiment of a product recommender shown in FIG. 13.

FIG. 15 is a block diagram of an embodiment of a sliding window associated with the product recommender shown in FIG. 14.

### DETAILED DESCRIPTION OF PREFERRED EMBODIMENTS

Embodiments of the inventive systems and methods we describe below refer to an easy, intelligent, and secure web based solution for managing personal finances. The systems and methods automatically pull together data from various financial institutions, and provide an updated, accurate view of a user's finances. The systems and methods go beyond just financial analysis by providing the user with personalized money saving recommendations. The systems and methods additionally allow the user to connect with other users who share their background and financial goals.

Embodiments of the inventive systems and methods provide an overview of all of the user's accounts and current balances even if they are held by several distinct financial institutions. Some embodiments allows for the user to customize alerts sent over email, text message, voice mail, or like. These alerts can tell the user of bank charges, when imposed, Automated Teller Machine (ATM) fees, and any unusual spending (either out of line given spending habits, outside of a particular geographic region, or otherwise). Embodiments of the inventive systems and methods show all of the user's transactions across all or a portion of his accounts, allowing the user to filter, categorize, tag, rename, and notate each transaction as he deems appropriate.

Notably, embodiments of the inventive systems and methods allow the user to connect with others that share the same background and/or financial goals. A user may form communities in a variety of ways including, by invitation. For example, a user may ask his friends and family to join him in his community allowing the sharing of advice, experiences, preferences, and other information within that community. The user may select any of a wide variety of characteristics to establish his personalized community.

In an embodiment, the inventive systems and methods automatically form user communities using any of a variety of system or user selected characteristics, including race, gender, profession, education, age, marital status, marriage, geographic location, home ownership, financial vehicles and institutions, and like. And the systems and methods may provide a means to show comparisons between the user and the rest of the community, while maintaining confidential the identities of the members of the community.

From this community, embodiments of the inventive systems and methods may make comparisons of the user's particular financial health against those in his community. For example, embodiments of the inventive systems and methods may indicate a favorable comparison of the user's savings habits against the saving habits of the community.

Embodiments may additionally provide recommendations personalized to the particular user. For example, if a user holds a predetermined amount of money in a savings account earning 3% interest, embodiments may recommend the user transfer this amount to 3- or 6-month certificate of deposit that will earn 6% interest. In an embodiment, the systems and methods may recommend one or more particular financial products from one or more financial institutions to meet the recommendation. And the systems and methods may compare the one or more particular financial products, allow the user to select a preferred financial product, and provide the appropriate links to the financial institution to automatically set up the user with the preferred product. These recommendations are based on a sophisticated recommendation engine we explain in more detail below.

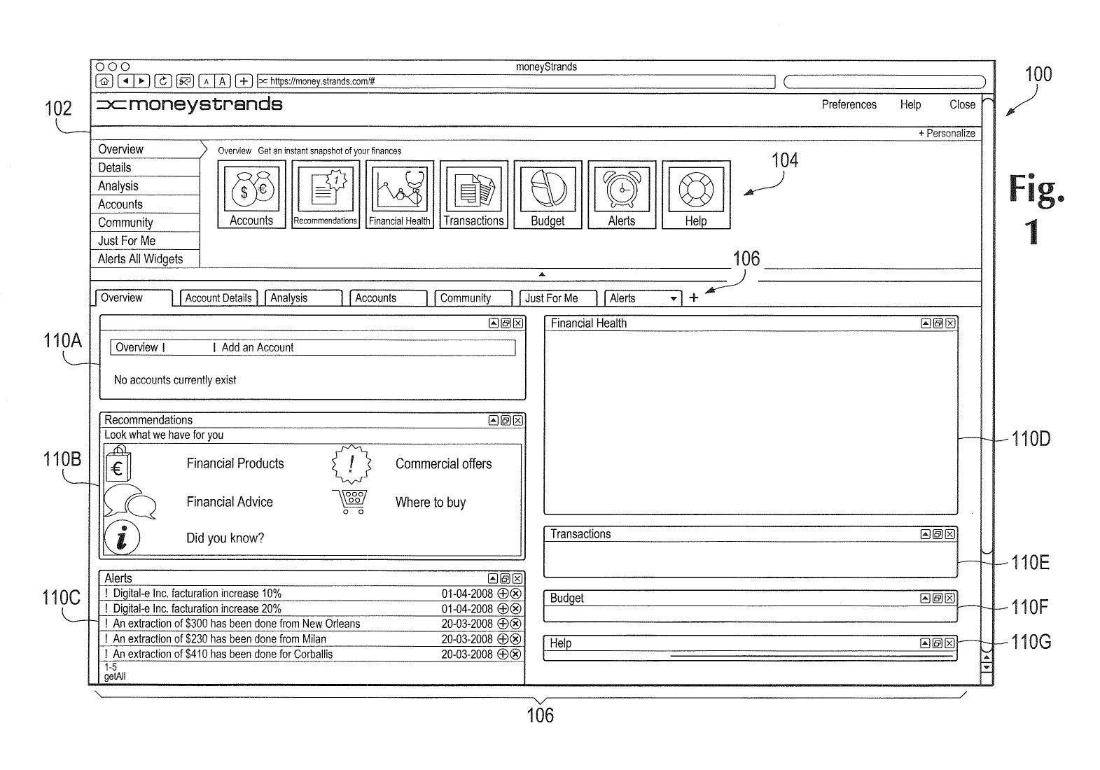

FIG. 1 is a screen shot of an embodiment of a user interface associated with the inventive systems and methods we describe below. Referring to FIG. 1, the user interface 100 provides an overview or instant snapshot of the user's personal finances and includes one or more sections in which to graphically display the available information. Bar menu section 102 displays a plurality of horizontally aligned and vertically stacked bars. These bars can include, for example, an Overview, Details, Analysis, Accounts, Community, Recommendations (Just For Me), and All Widgets bars. Clicking on a particular bar, for example, the Accounts bar, results in a display of the user's accounts in the detail display section 106. The widget section 104 displays the user's selected widgets from among a variety of customizable widgets including widgets associated with the Overview, Details, Analysis, Accounts, Community, Recommendations, and All Widgets bars.

A set of tabs 108 allows the user to traverse to the associated detail display section 106. For example, clicking on the Community tab displays the detail associated with comparisons of the user's personal finances to his community's personal finances, be it as anonymous individuals or as an anonymous group. And these comparisons' may be user customized. That is, the user may select what aspects of his finances, e.g., savings, spending, loan rates, and the like, he wants to compare to the community. Each tab has an associated detail display section 106 that may include one or more windows or screens displaying detail associated with the user's customization. For example, the Overview detail display section 106 includes a Accounts, Recommendations, Alerts, Financial Health, Transactions, Budget, and Help windows 110A-G, respectively.

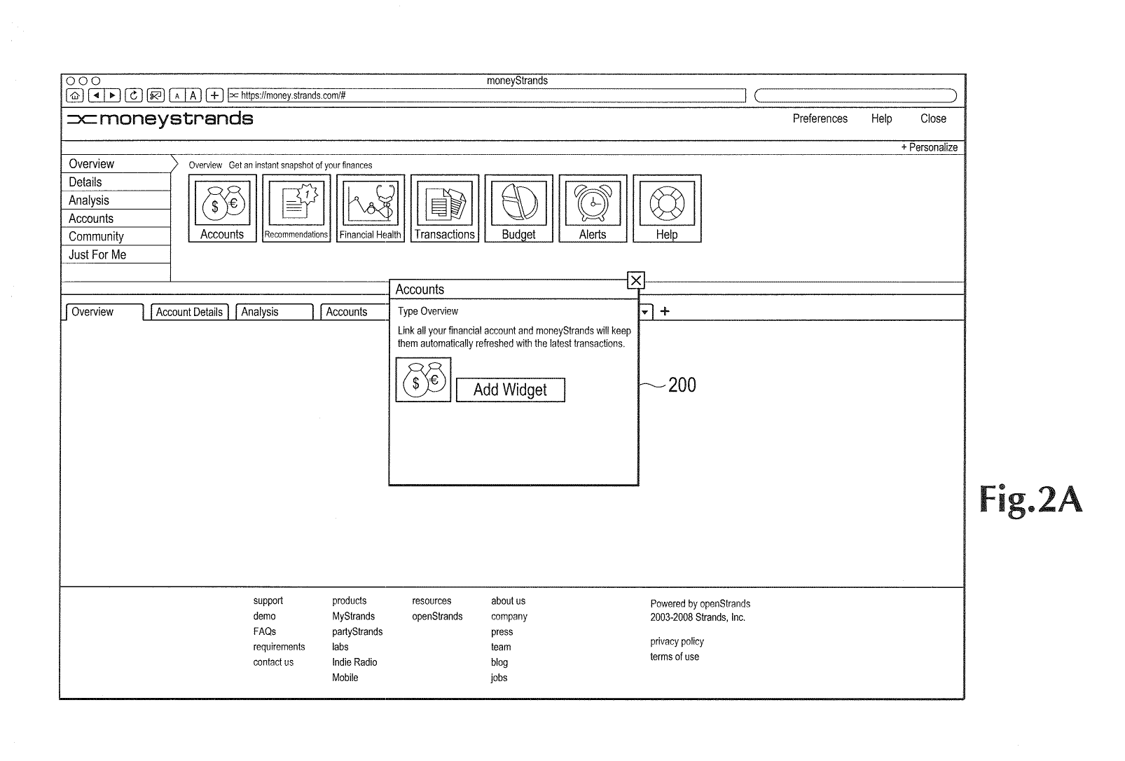

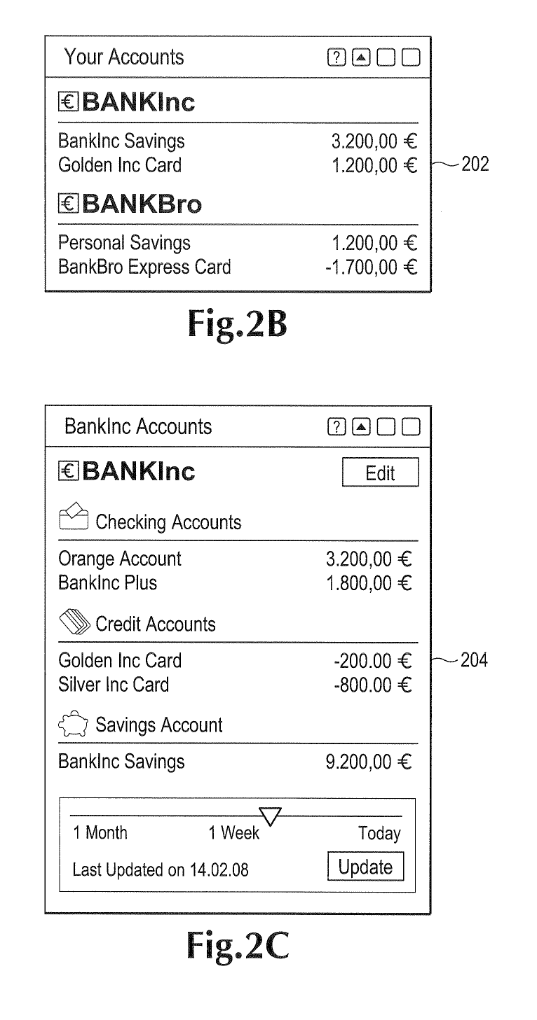

FIGS. 2A-C are screen shots associated with an embodiment of an Accounts widget 202 and 204 and its dialog box 200. In an embodiment, clicking on the Accounts widget dialog box 200 in the widget section 104 (FIG. 1) opens the widget 202 (or 204) to display an overview of the user's accounts as shown in FIG. 2B. Embodiments of the systems and methods allow the user to automatically link all of his financial accounts and to refresh the accounts with the latest transactions. The Accounts widget 202 displays all of the user's accounts in detail including account number, financial institution, balance, transaction history, and the like. The user can customize the level of account detail displayed by the Accounts widget 202. FIG. 2C, for example, shows details 204 associated with the user's accounts at one particular financial institution BankInc.

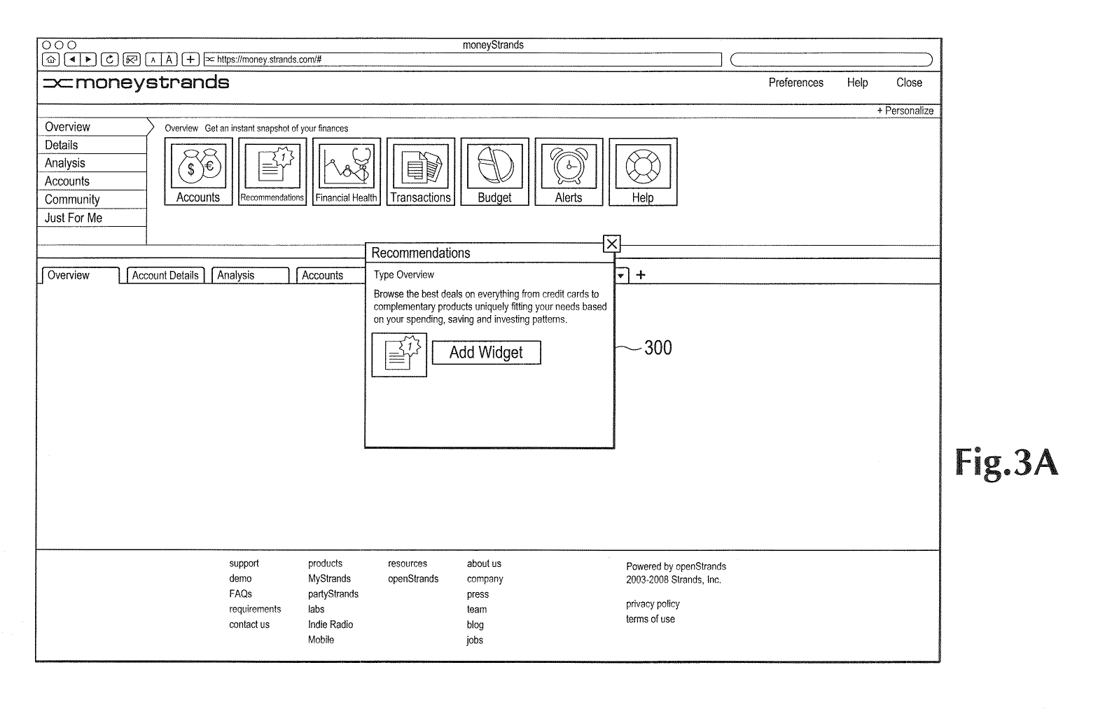

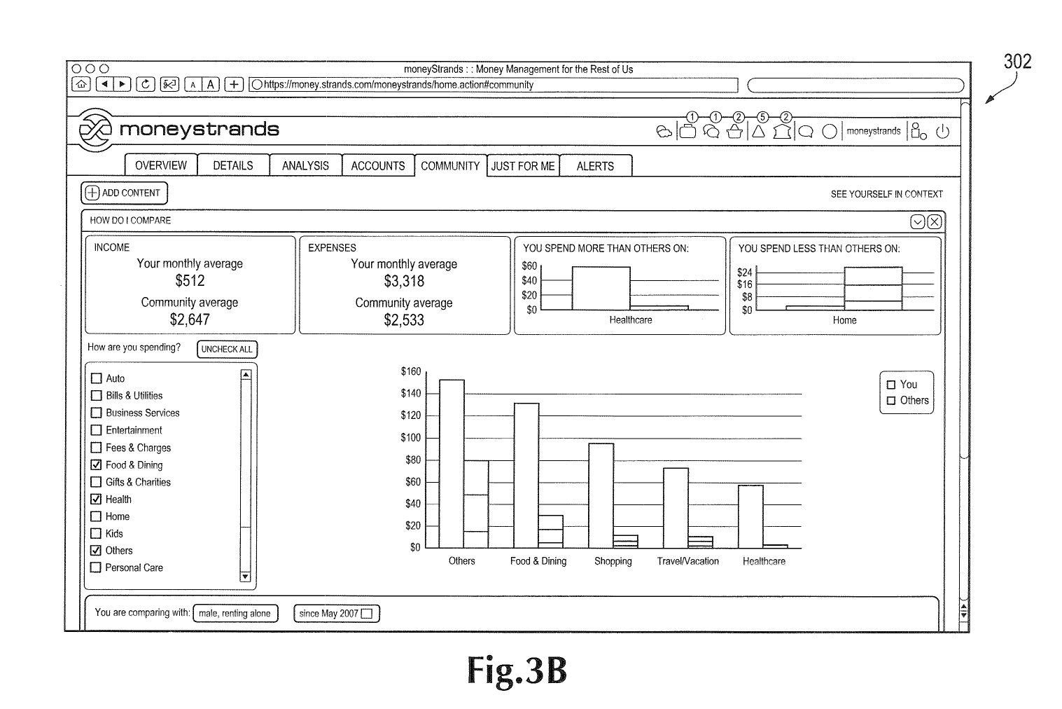

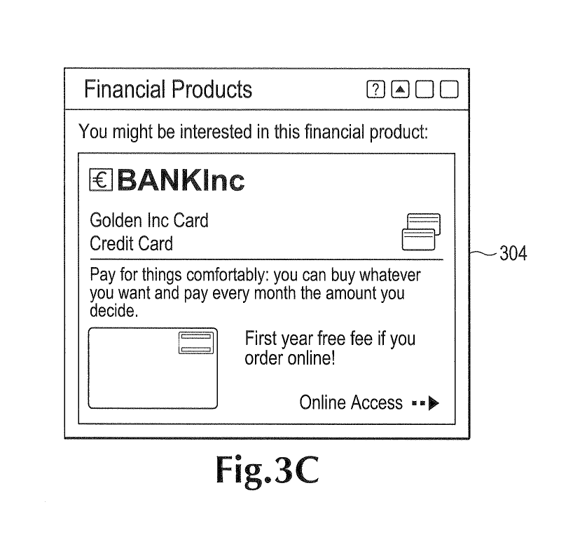

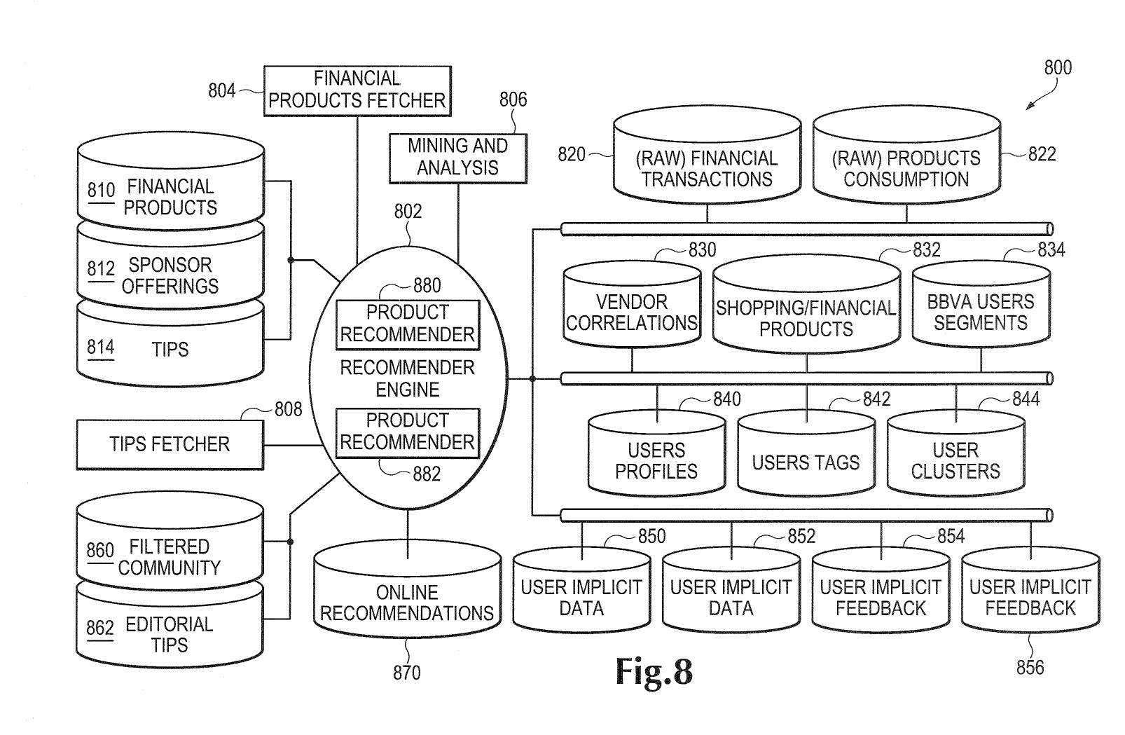

FIGS. 3A-C are screen shots associated with an embodiment of a Recommendations widget 302 and its dialog box 300. The Recommendations widget 302 allows the user to browse the best deals on everything from credit cards to complementary products uniquely fitting the user's needs based on his particular characteristics, including spending, savings, and investing habits and patterns as shown in more detail in FIG. 3B. FIG. 3C shows another type of recommendation 304 in which the user is offered a particular credit card showing benefits that perhaps his current credit cards do not offer as automatically determined for the user based on a sophisticated recommendations engine we explain in more detail below. Online recommendations, e.g., are indicated at reference 870 in FIG. 8.

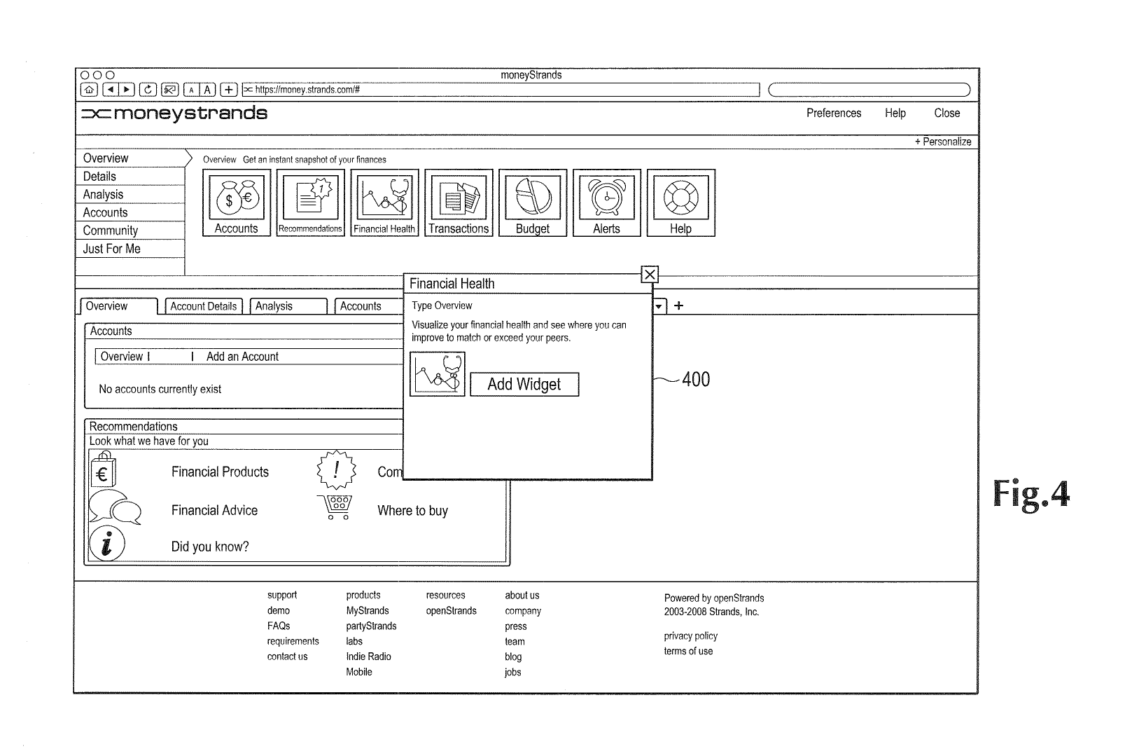

FIG. 4 is a screen shot associated with an embodiment of a Financial Health add a widget dialog 400. The Financial Health widget dialog 400 allows the user to visualize open a corresponding widget showing his financial health and to compare his financial health to others within his community. The community, as we have explained before, can include those invited by the user to form part of his community or can be automatically, and anonymously, generated by the methods and systems we present here. The user's financial health can be shown textually or graphically in any number of ways selected by the user. Embodiments of the systems and methods use pie charts, spreadsheets, line graphs, and other like graphical or textual analytical tools.

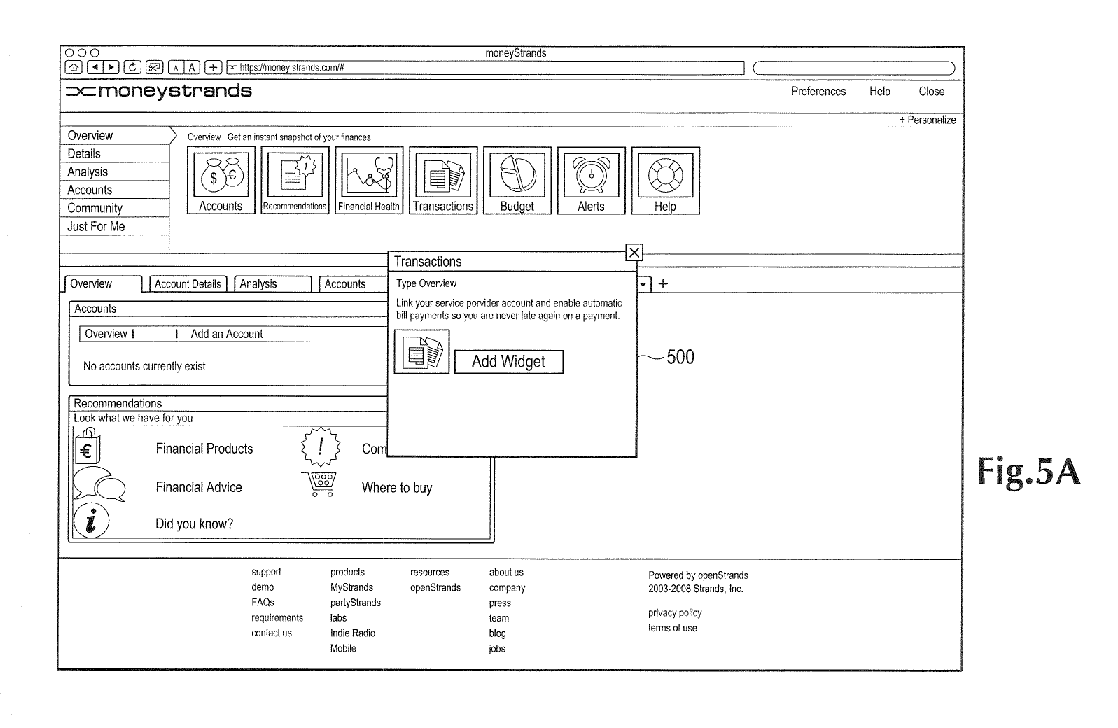

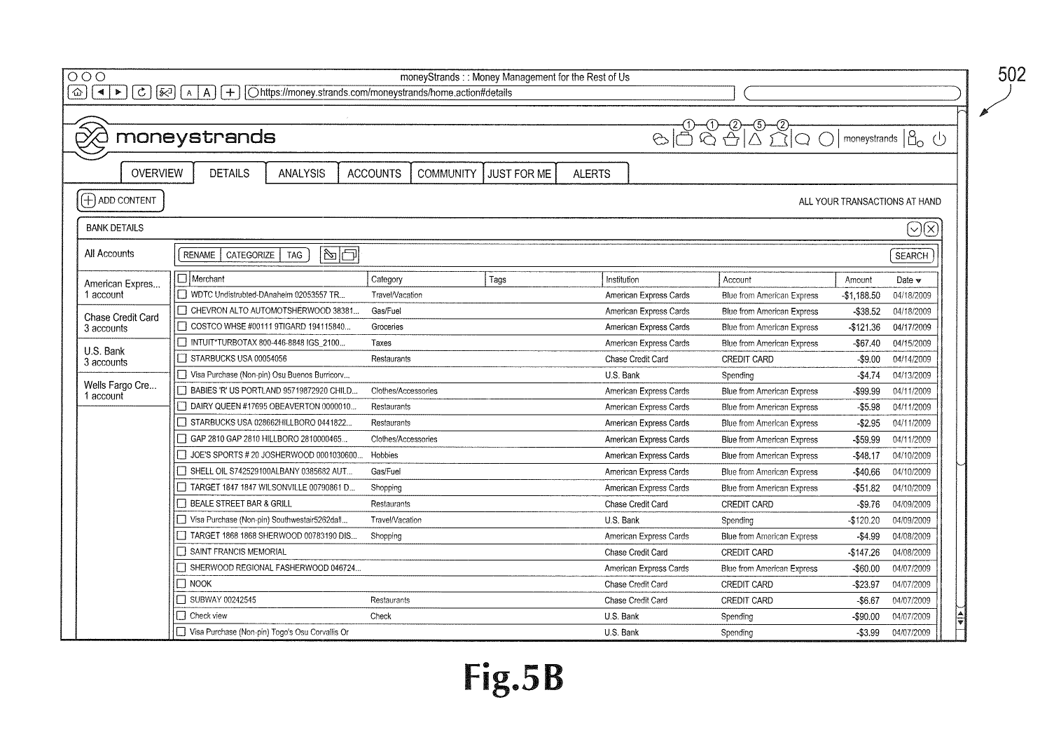

FIGS. 5A-B are screen shots associated with an embodiment of a Transactions widget 502 and dialog 500. The transactions widget dialog 500 shows the user detail associated with each transaction made in each of the user's accounts as shown in FIG. 5B. The widget 502 can display the transactions in any of a variety of manners including a list ordered by transaction date or otherwise. The Transactions widget 502 allows the user to enable automatic bill payments of credit cards, loans, mortgages, phone, electric, tuition, cable, and other services.

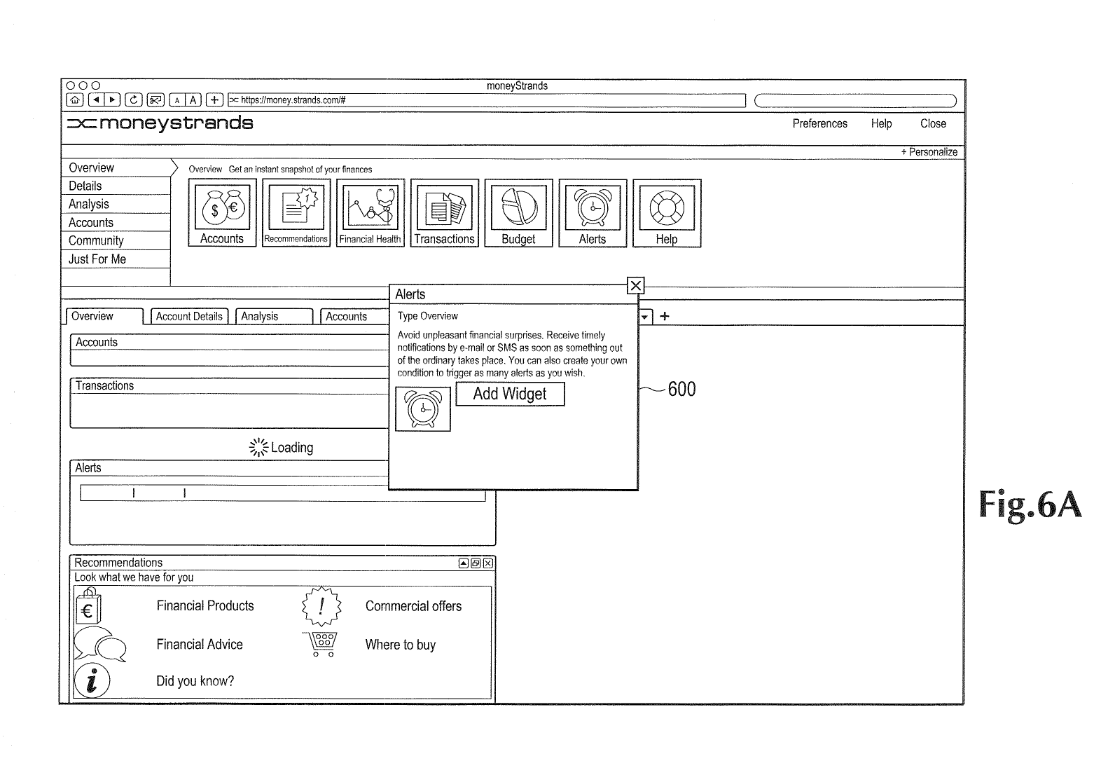

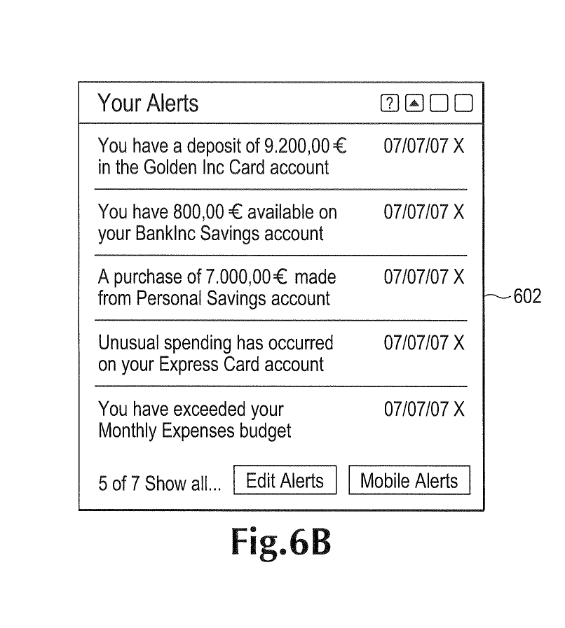

FIGS. 6A-B are screen shots associated with an embodiment of an Alerts widget 602 and dialog 600. The Alerts widget dialog 600 allows the user to open an alert widget 602 that will aid in avoiding unpleasant financial surprises by receiving timely notifications by email, voice mail, cell phone texting, or other mechanism as soon as something out of the ordinary takes place within any of the user's accounts. The widget 602 allows the user to customize his own alerts including the account identification (e.g., account number), the mechanism with which to receive an alert (e.g., by email to a particular address), and the condition or conditions that will trigger the alert (e.g., a checking account overdraft). FIG. 6B is an example of alert details from an alerts widget 602.

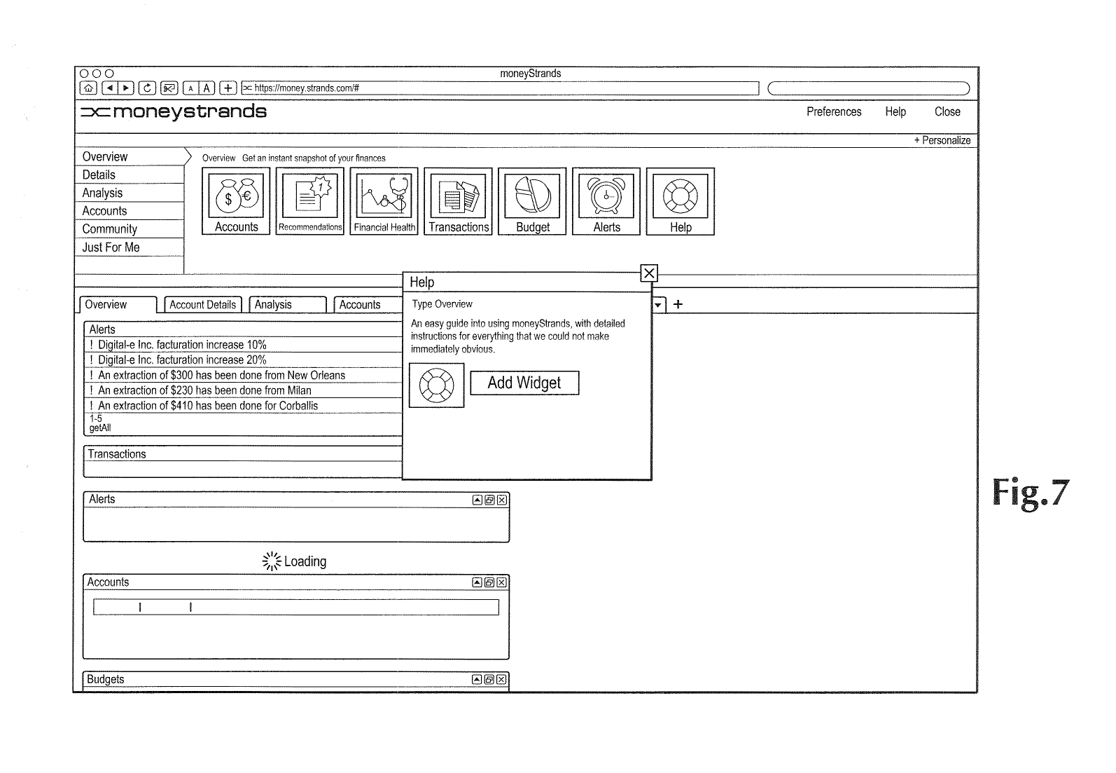

FIG. 7 is a screen shot associated with an embodiment of a Help widget dialog 700. The Help widget associated with the dialog 700 provides the user with an easy guide into using various features in the systems and methods we describe here, including providing detailed instructions for everything in the system that is not immediately obvious.

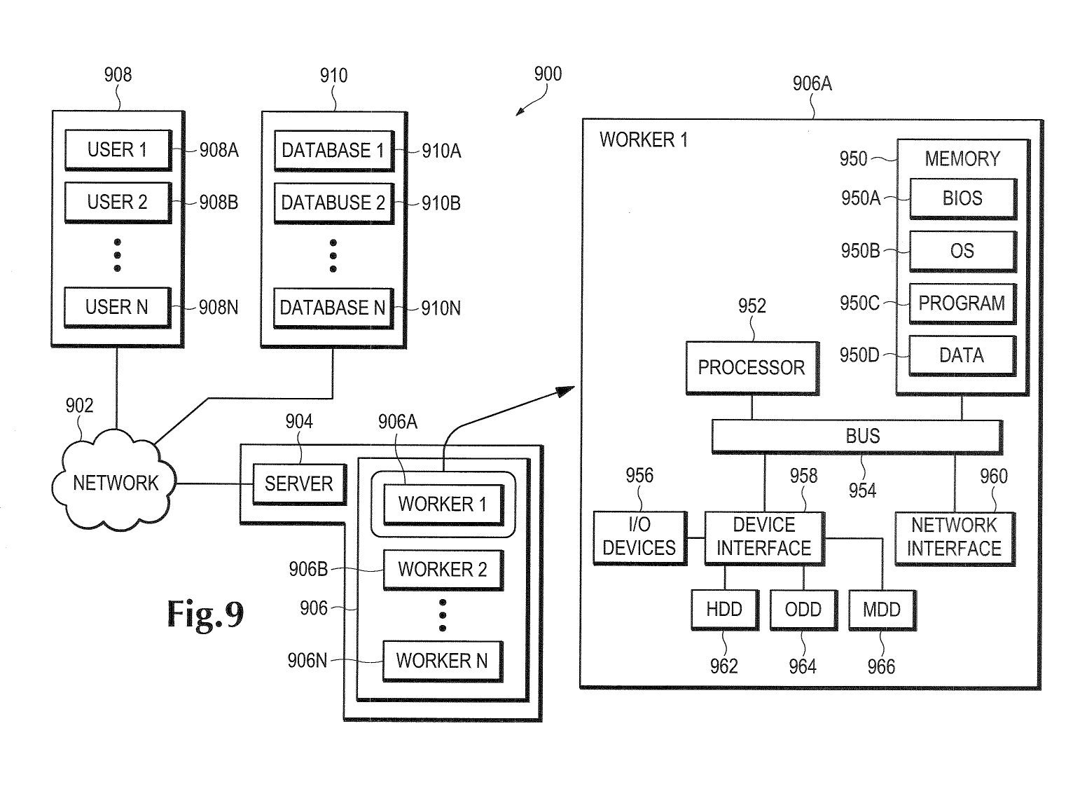

FIG. 8 is a block diagram of components associated with an embodiment of a recommender system 800 and associated methods. In one embodiment, the recommender system 800 includes a recommender engine 802 that is configured to make recommendations to a user based on the data mined and stored in the one or more databases or datastores, e.g., databases 810, 812, 814, 820, 822, 830, 832, 834, 840, 842, 844, 850, 852, 854, 856, 860, 862, and 870 shown in FIG. 8. The recommender engine 802 may be implemented as software on a hardware platform, an embodiment of which is shown in FIG. 9. In one embodiment, the recommender system 800 is presented to a user as a website running on a server (shown in FIG. 9) or the system 800 may be a standalone application. In this section, we examine the underlying data sources and algorithms that support the recommender system 800.

In one embodiment, data describing financial products can be acquired by a financial products fetcher application 804. The financial products fetcher 804 can employ any or all various known technologies to acquire information on financial products and services, and store them in one or more of the various databases or datastores, e.g., in databases 810, 812, or 814.

Database 810 contains data describing a variety of financial products and services. These products and services may be offered by banks or other financial institutions. In other words the data is supplied externally from such sources. A financial products fetcher application 804 may collect the financial products data using push or pull mechanisms, scraping the data from other online sources, or potentially from online search results. The financial products fetcher application 804 collects data or metadata describing financial products and services and stores the collected data in the database 810 so that it is available to the recommender engine 802. By way of example and not limitation, such products and services may include investments, such as certificates of deposits, securities, stocks bonds. Other products and services may include various types of bank accounts, savings accounts, credit cards, and the like.

Similarly, database 812 contains a collection of financial products and services that are offered by a particular sponsoring entity such as financial institutions. A sponsor entity is one having a relationship with the sponsor of the website or of the system 800 we describe above. The sponsor or affiliate financial institution may offer any or all the financial services summarized above. These offerings may be generated, by example, by mining the Customer Relationship Management (CRM) system of the affiliate or sponsor financial institution.

The next database 814 stores tips or suggestions to assist users in better managing their personal finances. This is general financial or personal financial management advice as distinguished from specific user recommendations that we further describe below. The tips or general advice stored in database 814 is made available to the recommender engine 802. Preferably generally advice is selected for delivery to the user from a website based on the particular group of users or community given which the user is a part. We further describe various user groups also, called segments or clusters, below.

Another application, the tips fetcher 808, acquires and manages tips that can include editorial tips stored in database 862 or filtered community tips stored in database 860. As we note above, the recommender engine 802 has access to the filtered community and editorial tips stored in databases 860 and 862, respectively. The recommender engine 802 can deliver the tips, as appropriate, to the users of a website implementing the inventive system 800 and associated method.

Databases 820 and 822 represents a variety of raw data sources, e.g., raw financial transactions and raw product consumption data associated with a particular user of the website. This refers to the raw data representing user's financial transactions and financial product use. For example, the user's financial transactions may include all of the various debits, credits, transfers, or other transactions that occur in the user's bank accounts. The same type of data may be acquired for the user's others accounts such as savings accounts, investment accounts, credit card accounts, and the like. in addition, a user's financial transactions might include mortgages or other types of loans.

User transaction data can be acquired in several ways. Some types of transactions may be entered by the user through the website user interface described earlier. Preferably, most financial transactions will be acquired by automatically periodically scrapping that data from external sources (not shown) using an application similar to the financial products fetcher. For example, the financial products fetcher can download a user's bank account transactions from the users bank website or internal databases, given the appropriate login credentials or other provisions to maintain security. Third party vendors are known, such as Yodlee, which are in the business of scraping financial data on behalf of users.

Mining and analysis component 806 mines and analyzes the financial transaction and product consumption data stored in the databases 820 and 822, respectively. The mining and analysis component 806 mines and analyzes the data for the user as well as the user's community of other users in a variety of ways as further explained below. The mining and analysis component 806 may analyze the data with respect to individual users, but also find various correlations between different aspects of the data across groups or clusters of users. The mining and analysis component 806 can store its results in one or more databases, e.g., databases 830, 832, or 834, which are available to the recommender engine 802 for use of making recommendations to individual users. In addition, correlation data may be stored in a knowledge base (not shown), coupled to the present system.

The databases 820 and 822 can store users' raw financial transaction and financial products consumption data. The data reflects the users various transactions and use or consumption of various financial products or services. These may include different types of products or services mentioned above. To take a simple example, the database 820 can store records for a particular user that show a mortgage on their principle residence, perhaps a second mortgage on the residence securing a home equity line of credit on a bank, certificate of deposit issued by another bank, and perhaps U.S. treasury obligations. The stored data can include interest rates, payment information, due date, and the like. This information can be used by the recommender engine 802 to make individualized recommendation for the user.

For example, the recommender engine 802 can determine that a particular user has one or more certificates of deposit that are soon to reach maturity. The recommender engine 802 might make some assessment as to how that money may be used or reinvested by the user, based on various factors, such as their current cash position and other obligations. If it appears appropriate for the user to reinvest the proceeds of a maturing certificate of deposit (CD) the recommender engine 802 would refer to the investment opportunities reflected in the databases 810, 812, or 814 for an appropriate investment and deliver the recommendation to the user through the website server as described above. This simple example is intended merely by way of illustration and not limitation.

In an embodiment, the system would have inputs such as previous financial product offers and purchases, user demographics and user portfolios. In one such instance, a 27-year old male has a steady increase of income over three months. Their bank account also shows a balance increase and their banking history shows that the user is not a regular investor. Using aggregated data across all users, we learn that people with these general traits (young, male, rising income, beginning investor) tend to invest in technology heavy mutual funds. Our system would use this pattern, among others, to serve recommendations.

Database 830 can store vendor correlation information that is based on user financial transactions stored in database 820 or user products consumption stored in database 822. We describe presently preferred techniques for determining such correlations below with regard to a preferred embodiment of the recommender engine 802. Additional correlation techniques are known, such as those used disclosed in U.S. patent application publication number 2006/0173910 (McLaughlin), which we incorporate here by reference.

The mining and analysis component 806 can generate correlations based on association-based counting or based on a vector space model. In general, association-based counting looks at lists of related items to determine which items to recommend to a user, based on one or more other items that a user is already known to be interested in. For example, if a large percentage of the current user's community who shopped at Nordstrom also shopped at Macy's, there exists a relatively high correlation value between vendor Nordstrom and vendor Macy's for that dataset.

Database 832 stores data that reflects correlations between individual items and financial products. Database 834 stores data identifying user segments for a particular group of users such as the users of an affiliated entity. That is, in some embodiments, the database 834 stores data defining sub-groups or segments of a particular community or group of users.

Database 840 stores a variety of user data including user profiles. The recommender engine 802 access the data stored in the database 840 (and others) to make recommendations to the user. The recommender engine 802 can store the recommendations in the database 870.

The user profiles can include, for example, basic identifying and contact information. This information may be provided, in part, by the user when setting up their account on the web site as described earlier. A user profile in some embodiments may also include demographic information, the user's age, marital status, children's ages, and like. Importantly, the user profile can also include additional information inferred by the system 800 based on other data available to it. For example, the financial transaction data stored in database 820 can include payments categorized as mortgage payments. The existence of a mortgage payment suggests that a user is a homeowner or landlord if the mortgaged property is not the same as the user's home address. Many other user profile data can be inferred. As another example, income transactions (bank deposits) from the U.S. federal government on a monthly basis may be social security payments, indicating that the user is retired (or possibly widowed or disabled). Numerous purchases of children's clothing and shoes would imply that the user has children, especially if this data is correlated with corroborating information, such as payment of pediatrician bills. FIG. 12 is a simple flow diagram illustrating an iterative process for inferring data from mining actual user transaction data. Proposed inferences can be verified by checking other correlation data available to the system, or asking the user for explicit verification.

Database 842 can store user's tags. Tags are words or phrases assigned by a user to particular transactions. This is somewhat analogous to the memo entered by a person on a paper check or in a legacy paper checkbook, to indicate something about the corresponding transaction. For example, a check (or online payment) to the state may be tagged as a tax payment or child support. Tags may be entered by the user, for example in connection with transactions entered by the user on the web site. Alternatively, the user may add tags, through the web site user interface, to transactions that were imported from various accounts. Tags may be very specific (“Fred's birthday present,” “Flight to Barcelona”) or more general (“Groceries”), indeed they can be anything the user creates.

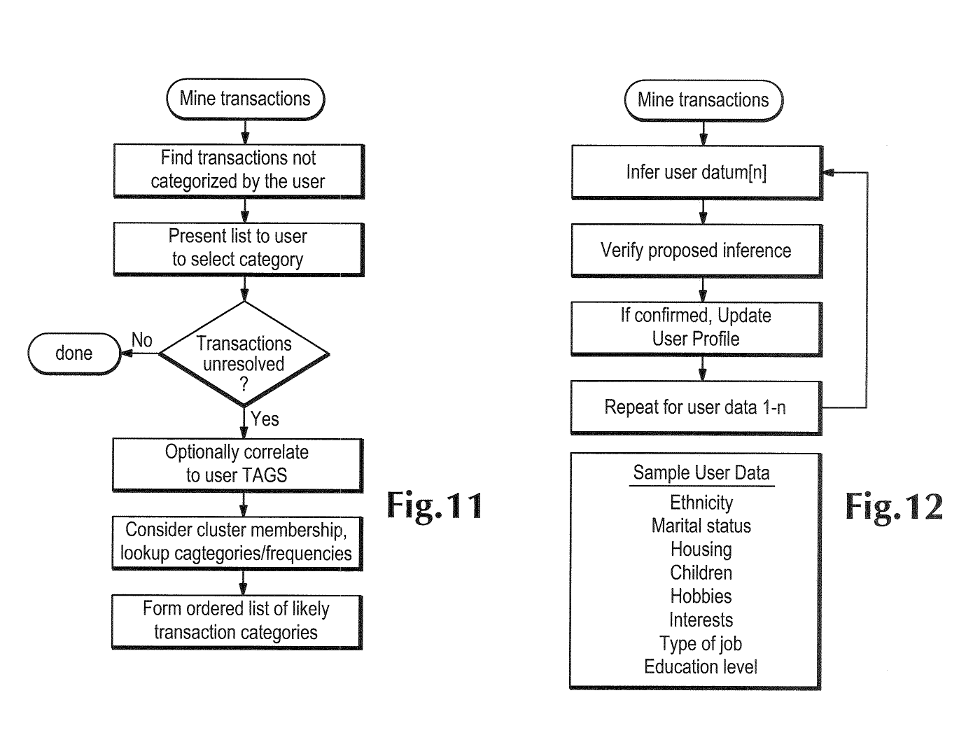

As a practical matter, many users will use tags, at least on occasion, that are similar or even identical to tags assigned by other users for similar transactions. This presents an opportunity for the mining and analysis component 806 to search for correlations, and use tags, together with other factors, to more effectively assign categories to transactions. By the term “more effectively,” we mean any or all of (1) assigning a correct category to a transaction, as distinguished from an incorrect category; (2) defining a new category; or (3) determining a sub-category of transactions. FIG. 11 is a simplified flow diagram related to assigning one or more (preferably one) predetermined category to a financial transaction. For example, an expense (credit card charge or debit transaction) may be categorized as “food” or “hotel” or “car rental.” In one embodiment, transaction data are reviewed to determine those for which a category is not yet known. These are presented to the user with an opportunity for the user to select a category, for example, using a pull-down selection. Before doing so, the preferred system may first attempt to determine an appropriate category. It may consider user tags for that purpose; by finding correlation values between tags (or key words found in tags) and predetermined categories. Other user information may also be used, for example, finding correlations to the user's community (or cluster).

Database 844 stores data defining one or more user clusters. This enables grouping or clustering of users based on any desired criteria, for example, data reflected in the user's individual profiles as stored in database 840. In addition to simple grouping say, based on gender, clusters can be derived by application of more sophisticated algorithms to available data such as those described in more detail below. Cluster information can be leveraged by the recommender engine 802 in making recommendations, for example, recommendations associated with vendors of financial products or tips stored in database 870. As a simple illustration, it would not be especially useful to send a tip urging saving for retirement to a cluster of retired people. This information can be useful in some embodiments to both make recommendations, and to filter recommendations so that the web site is more valuable to the user.

Database 850 stores data reflecting each user's implicit needs and preferences. Database 856 stores data reflecting a user's implicit feedback. By implicit we mean needs, requirements, or preference that are not directly input by a user, for example, by answering a question or making a selection at the web site interface. That type of data, user explicit data, is stored in a database 852. Rather, implicit data is that created, inferred, or otherwise determined by the system 800, for example, by the mining and analysis component 806, or the recommender engine 802, based on data available to the system 800. Importantly, available data includes both individual user data (stored in, e.g., databases 820, 822, 840, 852) and community or cluster data (stored in, e.g., databases 830 and 832). Moreover, in some embodiments, the implicit data can be affected (and improved) by user feedback (implicit or explicit), as we will see below.

Database 854 can store records that include explicit user feedback, i.e., feedback provided explicitly by the user through, e.g., the interface or website. In an embodiment, the engine 802 considers user feedback, be it explicit or implicit, to update or adjust correlation values. In general, one or more databases store correlation values among many different variables or items such as the types of data shown and described with reference to FIG. 8.

User Feedback

User feedback may be important in some embodiments, or in some situations, to improving the quality of recommendations made by the engine 800. Feedback generally takes either of two principle forms, explicit and implicit. Explicit feedback is provided directly by the user in response to a tip or recommendation delivered to them by the system 800. For example, in the recommendation widget 300 (FIG. 3A) described above, when say, a financial product is recommended to a user, the user can be asked to “click” an indication of the usefulness of the recommendation. That indication may be binary (useful/not useful) or it may employ any of various rating scales, for example, 1 to 5, all positive or neutral-centered. Such feedback is explicit.

Implicit feedback may be more important in some applications. Implicit feedback may be immediate (“click here for more info”) or delayed. Either way, a user's conduct with regard to the recommendation or tip is a direct reflection of the value of a tip or recommendation. In short, if a user accepts a recommendation, for example, by purchasing a CD recommended to her, that conduct implies a positive reaction to the recommendation. That conduct may be delayed by hours or days (or even longer). That reaction is likely to be more reliable than explicit feedback in some cases. User conduct may be reflected in actual transactions. These are captured and stored as discussed above e.g., relative to database 820. The recommender system 800 can associate (or identify correlations) between recommendations and subsequent user conduct, perhaps with a weighting factor that decays over time, depending on the nature of the recommendation. This implicit user feedback data is stored in a database, e.g., in database 856.

User feedback can be used to improve performance of the recommender engine 800. This may be done by adjusting the correlation values in the underlying knowledge base. In other words, user feedback may indicate that an apparently strong correlation, based on the raw data, is actually not as strong as it seems from the data.

The system 800 and the recommender engine 802 can be implemented on any number of computer systems, for use by one or more users, including the exemplary system 900 shown in FIG. 9. Referring to FIG. 9, the system 900 includes one or more general purpose or personal computers, e.g., user computers 908A, 908B, . . . , 908N, server 904, or worker computers 906A, 906B, . . . , 906N, that execute one or more instructions of one or more application programs or modules stored in corresponding system memory (not shown). The application programs or modules may include routines, programs, objects, components, data structures, and like that perform particular tasks or implement particular abstract data types. A person of reasonable skill in the art will recognize that many of the methods or concepts associated with the system 800, that we describe at times algorithmically may be instantiated or implemented as computer instructions, firmware, or software in any of a variety of architectures to achieve the same or equivalent result.

Moreover, a person of reasonable skill in the art will recognize that the system 800 we describe above may be implemented on other computer system configurations including hand-held devices, multi-processor systems, microprocessor-based or programmable consumer electronics, minicomputers, mainframe computers, application specific integrated circuits, and like. Similarly, a person of reasonable skill in the art will recognize that the system 800 we describe above may be implemented in a distributed computing system in which various computing entities or devices, often geographically remote from one another, perform particular tasks or execute particular instructions. For example, user computer 908A can be geographically remote from server 904, which, in turn, can be geographically remote from worker computer 906A. In distributed computing systems, application programs or modules, such as those used to implement an embodiment of the recommender engine 802, the financial products fetcher 804, tips fetcher 808, and the mining and analysis component 806, can be stored in local or remote memory.

The one or more general purpose or personal computers, e.g., user computers 908A, 908B, . . . , 908N, server 904, or worker computers 906A, 906B, . . . , 906N comprise a processor or processing unit 952, memory 950, device interface 958, and network interface 960, all interconnected through a bus 954. Each of the user computers 908A, 908B, . . . , 908N, server 904, or worker computers 906A, 906B, . . . , 906N can include a single or multiple processors 952. Each of the user computers 908A, 908B, . . . , 908N, server 904, or worker computers 906A, 906B, . . . , 906N can utilize the advantages offered by a distributed system in which available processing power in the one or more processors 952 in one or more of the computers is used by others of the computers. Each of the user computers 908A, 908B, . . . , 908N, server 904, or worker computers 906A, 906B, . . . , 906N can include one or more memory devices 950 including random access memory (RAM) or read only memory (ROM). The memory devices may include a basic input/output system (BIOS) 950A with routines to transfer data between the various elements of the computer system 900. The memory 950 may also include an operating system (OS) 950B that, after being initially loaded by a boot program, manages all the other programs in each of the user computers 908A, 908B, . . . , 908N, server 904, or worker computers 906A, 906B, . . . , 906N. These other programs may be, e.g., application programs 950C. The application programs 950C make use of the OS 950B by making requests for services through a defined application program interface (API). In addition, users can interact directly with the OS 950B through a user interface such as a command language or a graphical user interface (GUI) (not shown). In one embodiment, the recommender engine 802, the financial products fetcher 804, tips fetcher 808, the mining and analysis component 806, or combinations thereof include one or more APIs implemented on one or more of the user computers 908A, 908B, . . . , 908N, server 904, or worker computers 906A, 906B, . . . , 906N.

Device interface 958 may be any one of several types of interfaces including a memory bus, peripheral bus, local bus, and like. The device interface 958 can operatively couple any of a variety of devices, e.g., hard disk drive 962, optical disk drive 964, magnetic disk drive 966, or like, to the bus 954. The device interface 958 represents either one interface or various distinct interfaces, each specially constructed to support the particular device that it interfaces to the bus 954. The device interface 958 may additionally interface input or output devices 956 utilized by a user to provide direction to, e.g., the computer 906A and to receive information from, e.g., the computer 906A. These input or output devices 956 may include keyboards, monitors, mice, pointing devices, speakers, stylus, microphone, joystick, game pad, satellite dish, printer, scanner, camera, video equipment, modem, and like (not shown). The device interface 958 may be a serial interface, parallel port, game port, firewire port, universal serial bus, or like.

The hard disk drive 962, optical disk drive 964, magnetic disk drive 966, or like may include a computer readable medium that provides non-volatile storage of computer readable instructions of one or more application programs or modules 950C and their associated data structures. A person of skill in the art will recognize that the system 900 may use any type of computer readable medium accessible by a computer, such as magnetic cassettes, flash memory cards, digital video disks, cartridges, RAM, ROM, and like.

Network interface 960 operatively couples one computer, e.g., the computer 906A, to other computers, e.g., any of the user computers 908B, . . . , 908N, server 904, or worker computers 906A, 906B, . . . , 906N on a local or wide area network. Each of the user computers 908A, 908B, . . . , 908N, server 904, or worker computers 906A, 906B, . . . , 906N can be geographically local or remote from each other. Each of the user computers 908A, 908B, . . . , 908N, server 904, or worker computers 906A, 906B, . . . , 906N can have the structure of computer 906A, or may be a server, client, router, switch, or other networked device and typically includes some or all of the elements of computer 906. The computer 906A can connect to a local area network through a network interface or adapter included in the interface 960. The computer 906A may connect to a wide area network through a modem or other communications device included in the interface 960. The modem or communications device may establish communications to remote computers through global communications network 902. A person of reasonable skill in the art should recognize that application programs or modules 950C might be stored remotely through such networked connections.

We describe some portions of the system 800 using algorithms and symbolic representations of operations on data bits within a memory, e.g., memory 950. A person of skill in the art will understand these algorithms and symbolic representations as most effectively conveying the substance of their work to others of skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For expressively simplicity, we refer to these signals as bits, values, elements, symbols, characters, terms, numbers, or like. The terms are merely convenient labels. A person of skill in the art will recognize that terms such as computing, calculating, determining, displaying, or like refer to the actions and processes of a computer, e.g., user computers 908A, 908B, . . . , 908N, server 904, or worker computers 906A, 906B, . . . , 906N. The user computers 908A, 908B, . . . , 908N, server 904, or worker computers 906A, 906B, . . . , 906N manipulate and transform data represented as physical electronic quantities within the memory into other data similarly represented as physical electronic quantities within the memory. The algorithms and symbolic representations we describe above may result in data, files, records, and the like that are stored in one or more databases, e.g., databases 810, 812, 814, 820, 822, 830, 832, 834, 840, 842, 844, 850, 852, 854, 856, 860, 862, and 870.

The Recommender Engine

This section presents more detail of an embodiment of the recommender engine 802. The recommender engine 802 leverages two primary recommendation strategies: vector space modeling and association-based counting. Association-based recommendations may be based on either or both of behavioral data or metadata. Furthermore, association strengths may be computed by simple counting or more complex schemes that assign weights to individual correlates. Each technique can be optimized for runtime with some amount of pre-computation.

The recommender engine 802 can make at least two types of recommendations to a user: 1) tips, which are helpful ideas for improving financial health; and 2) products, which are one or more financial products offered by one or more financial institutions.

In an embodiment, the recommender engine 802 computes tip recommendations using a vector space model. The recommender engine 802 computes product recommendations using historic data associated with financial products, transactions, and other like financial data of the user and the user's community. By doing so, the recommender engine 802 is capable of accurately matching the user's interests and financial goals to the actual financial products that the engine 802 recommends. The recommender engine 802 is capable of making other types of recommendations using the system and methods disclosed herein without limitation.

The vector space model represents items and targeted users as documents and the documents, in turn, as vectors. The engine 802 calculates the relevance of a given item for a user as a function of the angle between their respective vectors. Association-based counting methods look at lists of related items to determine which items to recommend to a user based on other items that the user has shown an implicit or explicit interest in.

Following the base URL, or in the body of a POST request, one provides a set of parameters to create a specific recommendation request. For example, the request
./RecommendationServer.cgi?rectype=tip&seed=user|31415&num=1&fresh=20 requests a tip suitable for the user whose user ID is 31415.

TABLE 1
Illustrative Recommender Request Parameters.

| | |
|---|---|
| rectype | Specifies the desired type of recommendation(s). |
| user | The integer identification of the user to whom the |
| | recommendations are being targeted. |
| seed | The information upon which to base the recommendations. |
| filter | Constraints for personalizing and/or customizing the |
| | recommendations. |
| start | Zero-based offset of the first recommendation to be returned. |
| num | Desired number of recommendations. |
| fresh | Avoids repeating recently recommended items to the same user |

Details associated with the above parameters are as follows.

rectype—The parameter specifies the type of recommendations desired. For example, the rectype for getting tips is simply “tip”, while “vendor” is the rectype for vendor recommendations.

user—The parameter specifies the integer identification of the user on whose behalf the recommendations are ultimately being given. A value of 0 explicitly specifies the anonymous (or unknown) user. At most one -user- parameter may be specified. If no user is given, but a single user is given as a seed (see below), that user is taken to be the targeted user. If neither a user parameter nor a single user given as a seed, the targeted user defaults to the anonymous user.

seed—The parameter specifies the item or items on which to base the recommendations. The value has the form, in one embodiment, as follows:

<seedtype>|<seed1>[:<weight1>],<seed2>[:<weight2>],

The seedtype component specifies the type of the seeds that follow the vertical bar. Each of the seed components specifies a given seed. The weight components are optional, specifying a weight preferably normalized between 0 and 1 to control the influence of that seed relative to the other seeds. For example: seed=user|3 seed=category|35:0.5,36,37

Zero or more seed parameters may be specified, each having at least one seed component. If no seeds are given, the recommender may try to infer one or more based on the targeted user. If no seeds or user is given, the recommender will make a judgment as to the best recommendation for the given rectype. (For example, the recommender may simply recommend the most popular or highest rated items.)

filter—The optional filter parameter specifies a constraint for personalizing or customizing recommendations. Preferably, all filters have the same basic form:

<valueType>,<sense>,<preferenceLevel>|<value1>,<value2>,

The filter types are flexible and can vary according to implementation and preferences. An example filter from a music recommender that will limit recommendations to only those associated with either the blues or jazz genres is as follows:

filter=genre,true,0|Blues,Jazz

start and num—The optional start and num parameters control the offset and number of recommendations. Together they can be used for getting successive pages of recommendations.

For example:
start=0&num=10 // get the first 10 recommendations
start=10&num=10 // get the next 10 recommendations
start=20&num=10 // etc.

fresh—The optional fresh parameter ensures the user will not receive the same recommendations repeatedly. The fresh parameter filters out the last n stale recommendations. For example, “fresh=20” will return the best recommendation available after filtering out the last 20 recommendations received by the user. (If there are no recommendations possible after filtering out the stale ones, the recommender may return the least stale recommendation.)

Returned Results

In an embodiment, results are returned in the body of the HTTP response as a new line-separated list of pairs, where each pair consists of a recommended item and a value representing the strength of the recommendation. The results preferably are returned in descending order of strength so that the best recommendations come first. For example, a returned set of 5 vendor recommendations might look like the following:

Target 4.36707417412658

Kroger 3.94299345731926

Burger King 3.84631731208099

Starbucks 3.83256530590729

Subway 3.72688376838359

Association-Based Counting

The recommender engine 802 can use association-based counting to compute its recommendations, e.g., the tip or product recommendations. Association-based counting is almost as simple as it sounds. The recommender engine 802 takes note of every time two recommendable items associate in some meaningful context. The more the engine 802 notes an association between Item-A and Item-B, the better it considers Item-B to be a good recommendation given Item-A (and vice-versa). There are many variations on this theme.

For the sake of simplicity, assume that one or more of the databases shown in FIG. 8, includes a user's purchase history and his community of users' purchase history, including their colors. Assume that if the same user purchased two items, one with Color-1 and one with Color-2, that those two colors have a meaningful association. That is, assume that a user who likes Color-1 might like Color-2. From the database then, we can create lists of associated colors based on the purchase histories, see Table 3.

TABLE 3
SIMPLE ASSOCIATION LISTS

| USER | PURCHASED COLORS | | | | |
|---|---|---|---|---|---|
| U1 | C1 | C2 | C5 | C8 | C10 |
| U2 | C3 | C5 | C8 | C9 | |
| U3 | C1 | C2 | C3 | C7 | C10 |
| U4 | C2 | C8 | C10 | | |

| | |
|---|---|
| . . . | . . . |

Once the one or more databases are populated, the engine 802 computes the best recommendation from a given seed color by finding the color it is most often associated with. In our simple example, using only the data shown in Table 3, we would say that the best recommendation for a user known to like color c2 would be c10, because the association count is 3, more times than c2 is associated with any of the other colors.

Weighted Association Lists

The accuracy of the recommendations are oftentimes improved by weighting the items within the association lists. This makes sense when we have reason to believe that some items are more or less important as a correlate in relation to others. It also requires that we have some sensible way of computing the weights. Returning to our example color recommender, we can imagine two reasons why some terms might be considered more important than others. For one, if a user bought ten red products, ten pink products, but only one yellow product, we might assume that red and pink are more important to that user than yellow. By extension, we would assume that red and pink are more strongly correlated than red (or pink) and yellow.

Another possible reason to give one item a higher weight than another is if it occurs in fewer association lists. This can help separate out more meaningful correlations from ones derived more from the fact that some items are more heavily distributed, as an artifact of a given domain, than others. Imagine if almost every product is available in red, but only a few are available in pink. If we consider the meaningfulness of a correlation to be in some sense a function of its distance from what would be random chance, all other things being equal a correlation with pink would be more meaningful than one with red.

These weightings are well known in recommendation and information retrieval systems by the names term frequency (tf) and inverse document frequency (idf), respectively. One term, tf-idf, is used to describe applying both weightings.

instead of simply counting the number of times items occur together to get the best recommendation, the recommender engine 802 first computes a score for each occurrence of an association by multiplying the weights of each member of the association. To judge the association as a whole, we sum up the scores for each occurrence. Note that one could consider the simple counting method described above as a degenerative case of weighted association lists where all weights are 1.0.

Tips and the Vector Space Model

To apply the vector space model to tip recommendations, the engine 802 represents users and tips in a vector space where each dimension corresponds to a spending category, such as utilities or groceries. Each category is weighted from 0 to 1 according to how much the user spends in that category in relation to others in his or her community. For example, a user with a weight of 0.8 for groceries is one who spends as much or more as a percentage of his expenditures on groceries than 80% of other users in his community.

The engine 802 creates a vector for each tip in the system that represents what we would consider to be the ideal user to be given that tip. For a simple example, a tip to help people spend less on gas would have a high value in the dimension corresponding to the gas/fuel category (so that people who spend higher than average on gas would be more likely to get this tip). The best tip to recommend to a user, conceptually, is the one whose vector makes the smallest angle with the vector that represents the user who is the target of the recommendation.

Vector Space Model

The recommender engine 802 applies the vector space model to a set of documents to describe an n-dimensional space, where each distinct term across all the documents in the set corresponds to one dimension in the space. We use the word “documents” somewhat loosely in that they could be arbitrary text in natural language (as we usually think of documents) or they could be formally structured and formatted sets of terms with optional weights. In any case, an embodiment implementation of the vector space model describe a recommendable item or user as some kind of document, and then convert that document to a vector in the n-dimensional space mentioned previously.

As a simple example, imagine a color recommender based on the vector space model. Perhaps a product is available in any of 10 colors and the system 800 personalizes a product page for each user by showing the product in the color mostly likely to appeal to the user. Imagine, further, that the recommender engine 802 has access to one or more databases shown in FIG. 8 from which it can deduce the favorite color of each user (perhaps from previous purchases or a taste profile). The request to the recommender may look like:

../RecommendationServer.cgi?rectype=color&user=314159

The seed in this case is inferred from the one or more databases. The RGB color values represent each color as a structured document containing weights between 0 and 255 for each of the terms red, green, and blue (TABLE 2 BELOW). This gives us a three dimensional vector space in which to represent the user's favorite color and each of the colors for which the product is available. We can then compute among the vectors representing the recommendable colors, which have the smallest angle between it and the vector representing the user's favorite color. This we take to be the best color recommendation and can personalize the product page accordingly.

TABLE 2
REPRESENTING COLORS AS STRUCTURED “DOCUMENTS”.

| USER FAVORITE | COLOR-1 | COLOR-2 |
|---|---|---|
| DOC | DOC | DOC |
| Red = 17 | Red = 126 | Red = 20 |
| Green = 101 | Green = 218 | Green = 95 |
| Blue = 235 | Blue = 58 | Blue = 220 |

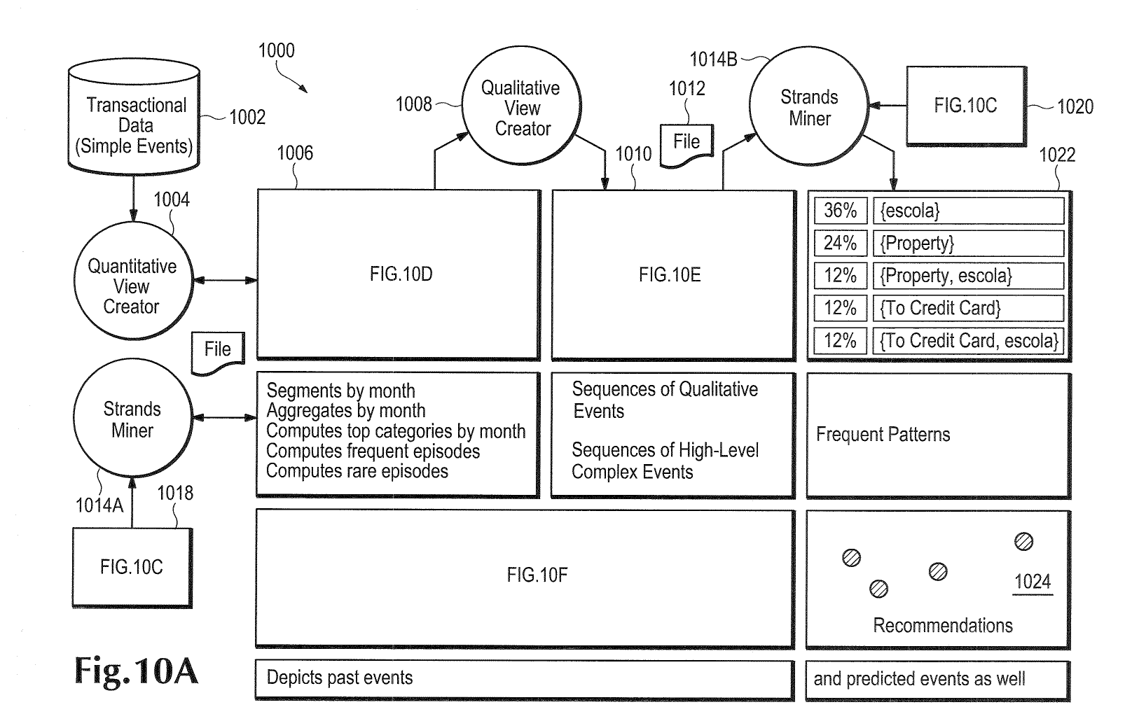

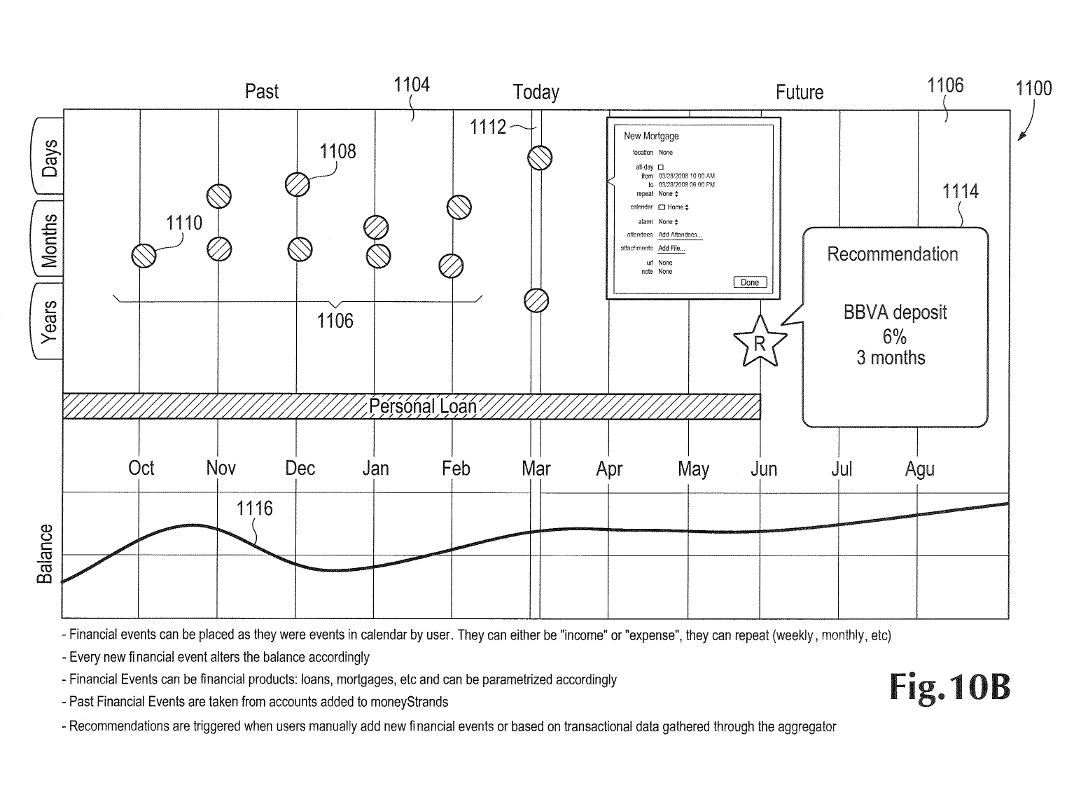

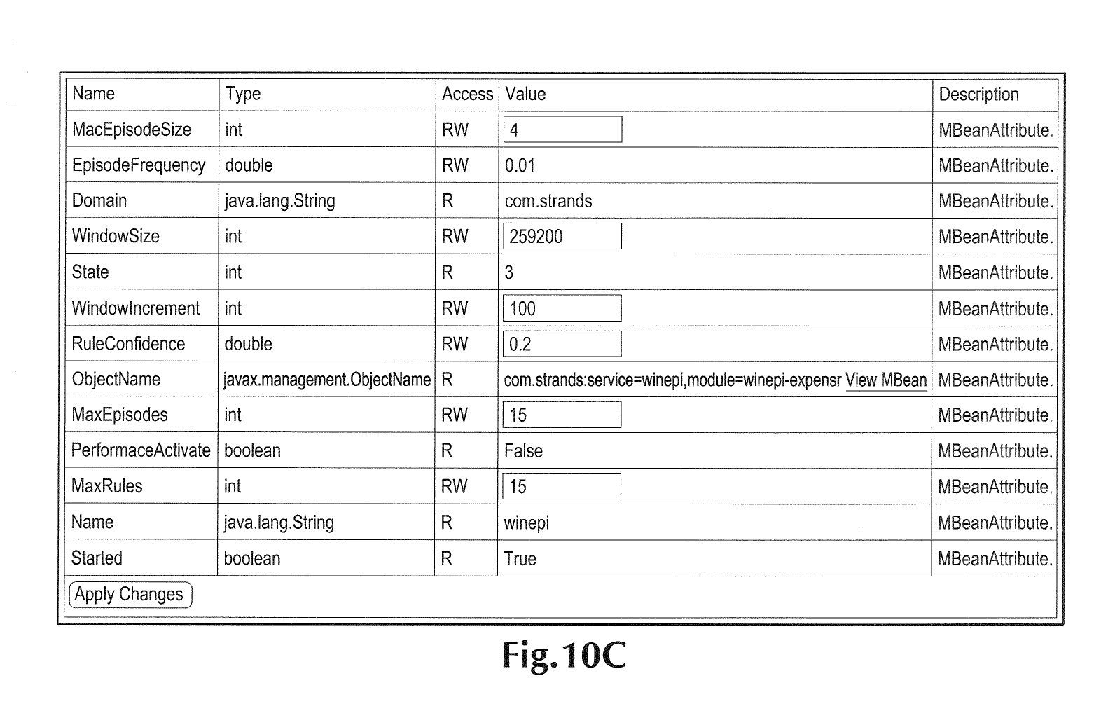

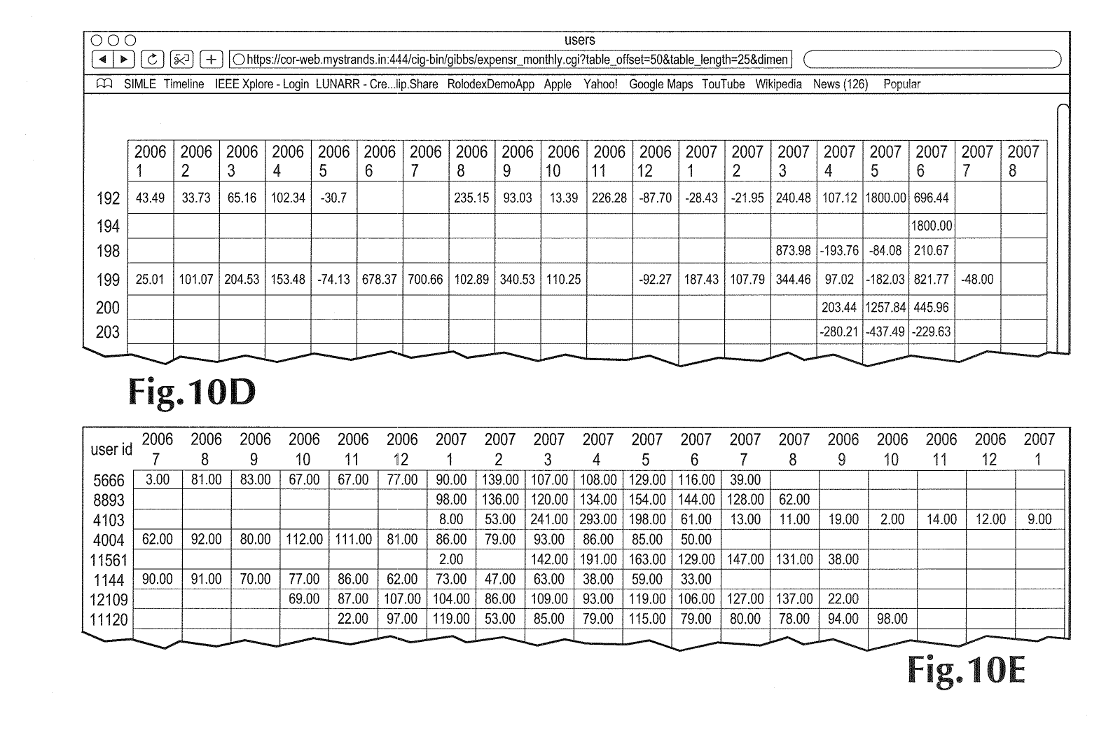

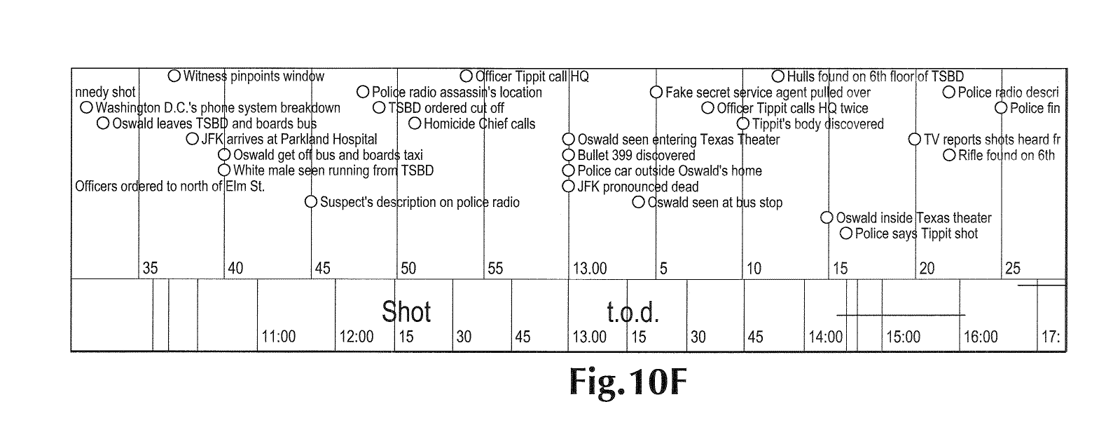

FIG. 10A is a block diagram of an embodiment of a system and method for hierarchical mining of transactional data. The system 1000 mines transactional data 1002 in a hierarchically manner to provide the user with recommendations particular to his financial health. Transactional data 1002 may include data from a community of users acquired through an aggregator such as a banking institution after due notice to its users. The transaction data may include data from other users of the system including users invited by the user to form part of his particular community. A quantitative view creator 1004 produces a quantitative analysis 1006 of the transactional data 1002. In an embodiment, the quantitative view creator 1004 breaks the data set into segments and builds a number of statistical measurements for each segment. These measurements may include statistical measures (e.g., median, mode, mean, standard deviation, and like), frequency distributions, and, when the segments are ordered, rates of change. In an embodiment, the measurements are accomplished by direct inspection of each transaction.

The quantitative view creator 1004 may use other data to produce the analysis 1006. An embodiment of the quantitative view creator 1004 displays the quantitative analysis 1006 as a spreadsheet but other mechanisms, including lists or graphs (3-dimensional and otherwise), are possible. A qualitative view creator 1008 qualifies the quantitative analysis 1006 to produce a qualitative analysis 1010. The qualitative view creator 1008 takes numerical measures from the quantitative view creator 1004 and adds qualitative labels to the data segments. These numerical measures may be simple rules or more complex analytical components depending on the application and needs.

An embodiment of the qualitative view creator 1008 displays the qualitative analysis 1010 as a spreadsheet but other mechanisms, including lists or graphs (3-dimensional and otherwise), are possible. The qualitative analysis 1010 may be saved in a file 1012 of any type. The file 1012 shows the possible serialization of the analysis performed by the quantitative and qualitative view creator 1004 and 1008. The serialization may include standard file formats like ARFF but could include other, proprietary formats. The data that is serialized can be the full data set or a subset of it based on the various qualitative and quantitative fields.

A strands miner 1014A analyzes the quantitative and qualitative analysis 1006 and 1010 to depict past events. The strands miner 1014A may use other data 1018 during its analysis. The other data 1018 may be system generated or external to the system. In an embodiment, the strands miner 1014A may segment the data by month, aggregate by month, compute top categories by month, compute frequent episodes, and compute rare episodes. The strands miner 1014A may graphically represent these past events in any of a variety of manners including textual and graphical manners. In an embodiment, the strands miner 1014A depicts past events using a timeline 1016.

A strands miner 1014B analyzes the quantitative analysis 1010 and other data 1020 to predict future events. The data 1020 may be system generated or external to the system. In an embodiment, the strands miner 1014B determines frequent financial patterns 1022 of the user and the community to make recommendations 1024 personalized to the user's financial health or situation. The strands miner 1014A-B may depict both the past events 1016 as well as its predictions of the future or recommendations 1022 in a timeline as is shown in FIG. 10B. The timeline 1100 is user customizable to show any particular level of detail for any particular period be it days, months, and years. The timeline 1100 may depict past events 1102 and predict future events 1104. The past events 1102 may be represented in any of a variety of manners, including by dots 1106. The dots 1106 may display different colors depending on whether the particular past event was beneficial to the user or whether the event was income or an expense. For example, a red dot 1108 may indicate a negative expenditure while a green dot 1110 may indicate a savings windfall such as through inheritance. Financial events may be financial products such as loans, mortgages, and the like. Financial events are capable of being parametrized.

A line 1112 may represent today, delineating the past from the future. The predicted events 1106 may represent recommendations personalized to the users' financial health. For example, a recommendation 1114 may indicate to the user that instead of having $10,000 in a savings account earning 3%, he would do better to transfer those funds to a cash deposit earning him 6% at the end of 3-months. A user may automatically trigger a predicted event or recommendation 1106 by adding new past financial events or through transactional data 1002 acquired through an aggregator.

The user's financial health may be shown as a line graph 1116 of his accounts' balances. The line graph 1116 shows the positive contribution of the recommendation 1114 on the user's financial health. Every new financial event in 1104 alters the line graph 1116.

Product Recommender

Referring back to FIG. 8, in an embodiment, the recommender engine 802 can include two individual recommenders, the product recommender 880 and the tag recommender 882. The product recommender 880 scores products, and more specifically, financial products, by predicting a user's interest over different financial products. The immediately following section describes the tag recommender 882. The engine 802 combines the results of the product and tag recommenders 880 and 882, respectively, to produce final user recommendations.

In one embodiment, the product recommender 880 retrains on demand so that it employs accurate user product history once deployed in a particular financial institution's environment.

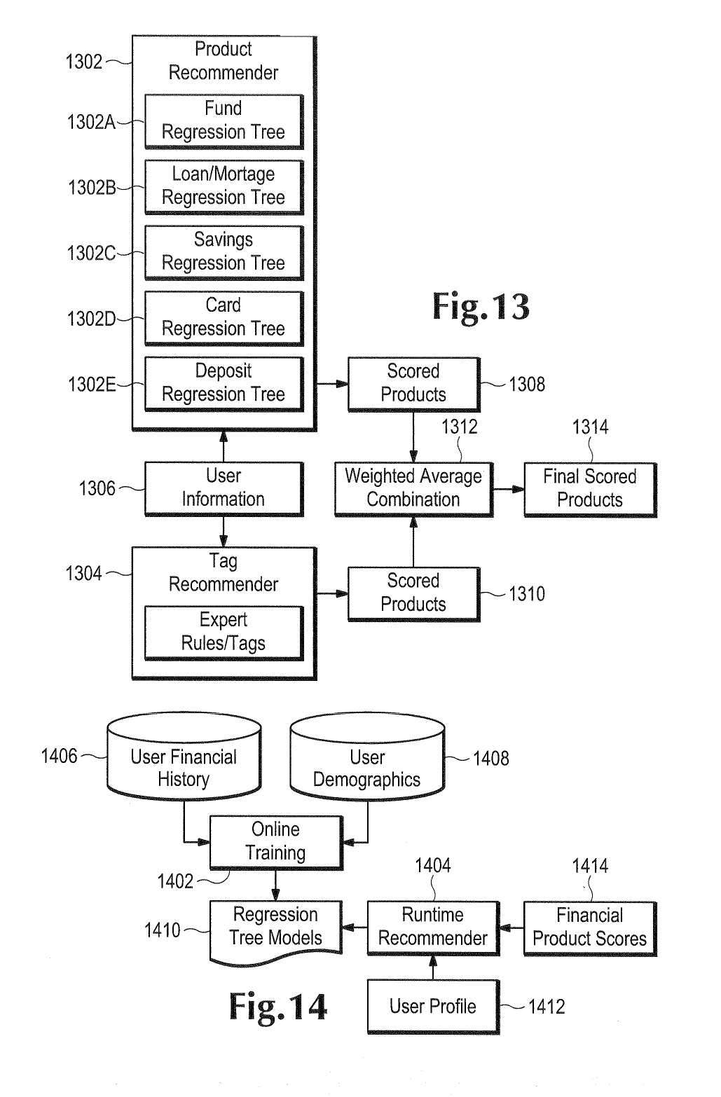

FIG. 13 is a block diagram of the recommender engine 802. Referring to FIG. 13, recommender engine 802 includes the product recommender 1302 and the tag recommender 1304. FIG. 14 is a block diagram of the product recommender 1302. Referring to FIGS. 13 and 14, the product recommender 1302 consists of an offline training process 1402 and an online recommendation process 1404. The offline process 1402 receives user financial history data 1406 and user demographics 1408 to create models of financial product purchasing behavior, e.g., using regression tree models 1410. The online process 1404 takes a user profile 1412 and evaluates the models to predict their interest as scores 1414 across the financial products, e.g., funds, loans, savings accounts, credit cards, deposits.

In an embodiment, the product recommender can use supervised learning approach to predict a user's likelihood of purchasing a financial product. The product recommender 1302 creates a separate supervised model for each financial product. in an embodiment, the product recommender creates a fund regression tree 1302A, loan/mortgage regression tree 1302B, savings regression tree 1302C, card regression tree 1302D, and deposit regression tree 1302E.

The following is an example regression tree for predicting the likelihood that a user will purchase a fund. The tested attributes, such as FND EVER, are defined below. The example regression tree represents a standard binary tree where the root node has no indention and each level of tree depth is indented accordingly.

FND_EVER < 1.5
| FND_EVER < 0.5 : 0 (23245/0) [11665/0]
| FND_EVER >= 0.5 : 0.03 (3476/0.03) [1701/0.03]
FND_EVER >= 1.5
| FND_EVER < 9.5
| | FND_RECENT < 0.5
| | | OVERALL_NET < 22870.32
| | | | CCD_ACTIVE < 3.5
| | | | | INCOME < 3376.96 : 0.04 (801/0.03) [369/0.04]
| | | | | INCOME >= 3376.96 : 0.07 (824/0.06) [443/0.07]
| | | | CCD_ACTIVE >= 3.5 : 0.08 (432/0.08) [233/0.06]
| | | OVERALL_NET >= 22870.32 : 0.14 (190/0.12) [82/0.13]
| | FND_RECENT >= 0.5 : 0.15 (308/0.12) [152/0.15]
| FND_EVER >= 9.5
| | FND_RECENT < 1.5 : 0.14 (571/0.13) [274/0.11]
| | FND_RECENT >= 1.5 : 0.36 (48/0.23) [29/0.23]

To illustrate, assume we have a user that has owned 12 funds over the course of their history with a particular financial institution. One of those funds was recently opened a month ago. The regression tree first determines whether the user has owned 2 or more funds. If the result is true, the regression tree determines whether the user has had 10 or more funds. If the result is also true, the tree tests whether the user has recently acquired 2 or more funds. In our example, this is false so the tree ends up at the following leaf:

||FND_RECENT <1.5:0.14 (571/0.13) [274/0.11]

The leaf should be interpreted as follows:

FND_RECENT <1.5:0.14

Since the user only acquired one fund recently, the regression tree predicts he has a 14% chance of acquiring a fund in the next two months

(571/0.13)

These numbers give us information about how the tree was trained. The first number indicates that there were 571 training instances that evaluated as true for this leaf in the tree (just as our user did). The second number reveals that those instances had an average error of 0.13 (given that the leaf is outputting 0.14 as the prediction). In other words, the regression tree indicates a lack of confidence in the prediction.

[274/0.11]

These last two numbers are similar to the previous two. However, this time the regression tree indicates that 274 holdout instances evaluated to true for this leaf in the tree. The holdout data is essentially a miniature test set including data not used for growing the tree, but “held out” to verify that the tree is predicting adequately. The 274 holdout instances had an average error of 0.11. That the holdout error is smaller than the error observed in the training set indicates that the regression tree is not over fitting. If the holdout error is larger than the training error, the regression tree is over fitting the data.

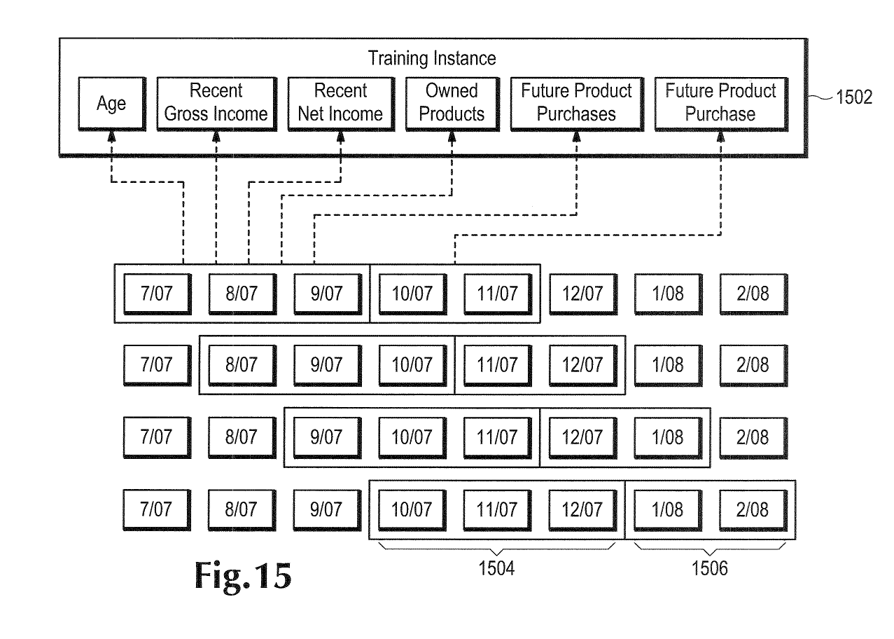

Referring to FIG. 15, to generate the training data, the product recommender 1302 uses a sliding window 1502 across each user's financial products purchase history. In the embodiment of the sliding window 1502, each frame of the sliding window 1502 produces five training examples, one for each product.

The inputs are the same for each of those five training instances. The sliding window 1502 uses a three-month history period 1504 and a two-month target period 1506. The history period 1504 captures the user's recent activity, e.g., gross and net income, expenses, owned products, and recently purchased products. The product recommender 1302 adds the user's profile 1306 including e.g., age and number of credit cards. In an embodiment, a target output depends on the financial product. For a credit card training instance we set the target output to 1.0 if the user purchased a credit card during the two-month target period 1506. Otherwise, the target output is set to 0.

The sliding window 1502 converts sequential data into a form that is easy to use with many classical machine-learning techniques. More specifically, the product recommender 1302 includes one or more regression trees since they offer quick training times and transparency. In contrast to many machine learning models, the results of a regression tree are human understandable.

In an embodiment, the product recommender 1302 assumes that the data is independent and identically-identified random variables although this is an oversimplification. In other embodiments, the product recommender 1302 uses dynamic models that explicitly capture sequential patterns such as hidden Markov models or hidden-state conditional random fields. The product recommender 1302 can populate one or more tables with training data using sliding windows, e.g., window 1502. The product recommender 1302 can initialize one or more tables before obtaining the first training data, and can use placeholder models for predicting user interest. Alternatively, the product recommender 1302 can replace the initial models with the previously trained models before deployment.

In an embodiment, the product recommender 1302 can additionally receive one or more of the following inputs.

| Attribute Name | Description |
|---|---|
| AGE | Age of the client in years. |
| EXPENSE | The client's total expenses for the most recent month. |
| INCOME | The client's total income for the most recent month. |
| TMINUS1_EXPENSE | The client's total expense for the previous month. |
| TMINUS1_INCOME | The client's total income for the previous month. |
| TMINUS2_EXPENSE | The client's total expense for the month two months previous |
| TMINUS2_INCOME | The client's total expense for the month two months previous. |
| OVERALL_INCOME | The client's total income over the last three months. |
| OVERALL_NET | The client's net income over the last three months. |
| CCD_ACTIVE | The number of currently active credit cards possessed by the client. |
| CCD_EVER | The total number credit cards ever possessed by the client. |
| CCD_RECENT | The number of credit cards acquired by the client in the last three months. |
| SAC_EVER | The total number savings accounts ever possessed by the client. |
| SAC_RECENT | The number of savings accounts acquired by the client in the last three months. |
| DEP_ACTIVE | The number of currently active deposit accounts possessed by the client. |
| DEP_EVER | The total number deposit accounts ever possessed by the client. |
| DEP_RECENT | The number of deposit accounts acquired by the client in the last three months. |
| FND_EVER | The total number funds ever possessed by the client. |
| FND_RECENT | The number funds acquired by the client in the last three months. |
| LNS_ACTIVE | The number of currently active loans possessed by the client. |
| LNS_EVER | The total number loans ever possessed by the client. |
| LNS_RECENT | The number of loans acquired by the client in the last three months. |

In an embodiment, the product recommender 1302 can operate on one or more tables of financial products as follows.

Required for Product Type Recommender

CREDIT_CARDS
SAVING_ACCOUNTS
LOANS
FUNDS
DEPOSITS
USER_CATEGORY_STATS
USER_CONNECTIONS
USER_PROFILE
FP_BBVA_PRODUCTS

In an embodiment, the tag recommender 1304 can operate on one or more tables of tags as follows.

Required for Tag Recommender

TAGS
FP_BBVA_TAG_PRODUCTS
FP_BBVA_PRODUCTS

In an embodiment, CREDIT CARDS, SAVING ACCOUNTS, LOANS, and DEPOSITS tables can be the source for the input features relating to a user's product portfolio. The USER CATEGORY STATS table provides user income and expense information for each month. The USER CONNECTIONS table is a linking table showing connections between tables. FP BBVA PRODUCTS table contains a particular financial institution's (i.e., BBVA) product catalog. Finally, the USER PROFILE table provides, as the name implies, the user's age among other data.

The product recommender 1302 can update the USER CONNECTIONS table periodically, e.g., once a month, with the results from aggregating credit card transaction data. The product recommender 1302 can be retrained also periodically, e.g., once a month, after the updating the USER CONNECTIONS table.

In one embodiment, the regression trees 1302A-D can be part of the so-called Weka (Waikato Environment for Knowledge Analysis) machine learning software suite, developed at the University of Waikato in New Zealand. The Weka suite contains a collection of visualization tools and algorithms for data analysis and predictive modeling, together with graphical user interfaces for easy access to this functionality. Weka supports several standard data mining tasks, more specifically, data preprocessing, clustering, classification, regression, visualization, and feature selection.

In an embodiment, the product recommender 1302 uses the weka.classi_ers.trees.REPTree regression tree. The result of our training process produces two files for each financial product. The model file is the serialized REPTree class. The aml file is a serialization of Weka's Instances class that contains information about the expected input features (or attributes) for its respective tree.

The following table lists exemplary locations of each model artifact (both the project repository location and the deployed location):

| Training Artifacts (Project) | Training Artifacts (Deployed) |
|---|---|
| src/main/resources/account.aml | WEB-INF/classes/account.aml |
| src/main/resources/account.model | WEB-INF/classes/account.model |
| src/main/resources/creditcard.aml | WEB-INF/classes/creditcard.aml |
| src/main/resources/creditcard.model | WEB-INF/classes/creditcard.model |
| src/main/resources/deposit.aml | WEB-INF/classes/deposit.aml |
| src/main/resources/deposit.model | WEB-INF/classes/deposit.model |
| src/main/resources/fund.aml | WEB-INF/classes/fund.aml |
| src/main/resources/fund.model | WEB-INF/classes/fund.model |
| src/main/resources/loan.aml | WEB-INF/classes/loan.aml |
| src/main/resources/loan.model | WEB-INF/classes/loan.model |

The product recommender 1302 will periodically load or update the models. The product recommender 1302 can do this automatically or manually responsive to a user. The aml files can be very small, e.g., approximately 3 KB. The model files can vary in size depending on the size of the regression tree, e.g., from fairly small and to less than 50 KB.

In an embodiment, the product recommender 1302 considers at least two parameters during training. The first parameter is the user sample size that is set during start up or initialization of the train. The user sample size defines how many unique users to select from the USER CATEGORY STATS table when generating data. Once a user is selected, their amount of history determines how many training examples are generated from the user's associated data. The training window 1502 (FIG. 15) can use any number of months, e.g., five months total with three history months and two target months. For another example, six months of user history would generate two training examples. Ten months would generate six examples. If 50,000 users were sampled with an average history of 14 months, the product recommender 1302 can generate approximately 500,000 training examples.

The second parameter is a maximum number of training rows, e.g., maxTrainingRows. This parameter is set in a configuration file, e.g., the configuration file found at src/main/resources/config.properties or instead found at WEB-INF/classes/config.properties when deployed.

This parameter controls a second stage of sampling. The default value is 100,000. Continuing our previous example, if we sample 50,000 users and generate 500,000 training examples then by default the maxTrainingRows parameter will sample 100,000 examples from the 500,000 total examples. In an embodiment, the product recommender 1302 applies this second stage filtering to maximize limited memory usage in one or more servers running the application. In another embodiment, the product recommender 1302 runs the application on a separate server or system thus eliminating some of the memory restrictions. In that case, the product recommender 1302 can set the maxTrainingRows much higher, e.g., a million or more depending on memory availability. The trained models could then simply be copied to the server running the recommender system 800 (FIG. 8).

Tag Recommender

Referring to FIG. 13, the product recommender 1302 predicts a user's interest across the financial products. The tag recommender 1304 aids the recommender engine 802 in identifying a particular financial product within the various types of financial products. The tag recommender 882 ranks products, and more specifically, financial products, according to predetermined rules applied to user profiles.

For example, the product recommender 1302 can identify a user's interest in a credit card, while the tag recommender 1304 can identify a user's interest in a particular one of the various credit cards available, e.g., gold or silver credit cards.

In an embodiment, the tag recommender 1304 creates one or more predetermined rules against which it evaluates the list of financial products generated by the product recommender 1302. The following is an exemplary set of rules.

Algorithm 1 marketing rules
if savingForHouse then
recommend MORTGAGE FACIL with confidence 0:8
recommend MORTGAGE V ENACASA with confidence 0:8

else if age is null AND balance > 6000 AND cashFlow > 200 per month
then

recommend MORTGAGE FACIL with confidence 0:3
recommend MORTGAGE V ENACASA with confidence 0:3
else if age > 30 AND balance > 6000 AND cashFlow > 200 per
month then
recommend MORTGAGE FACIL with confidence 0:4
recommend MORTGAGE V ENACASA with confidence 0:4
end if

These rules, however, reference specific products of a specific financial institution, e.g., BBVA. To avoid having the recode the rules when a the financial institutions updates or changes its product offerings, the tag recommender 1304 uses a limited predetermined set of tags that describe particular financial products. When the financial institution adds a new financial product, its tags are also added to the database. This allows the tag recommender 1304 to convert the marketing rules to use tags and then apply the rules to any new product

The following shows an exemplary set of rules converted for use by the tag recommender 1304.

Algorithm 2 Tag-Enabled Marketing Rules
if savingForHouse then
recommend mortgages tagged SAVING FOR HOUSE with
confidence 0:8
else if age is null AND balance > 6000 AND cashFlow > 200
per month then
recommend mortgages tagged MED ACCT BAL AND POSITIVE

CASH FLOW with confidence 0:3

else if age > 30 AND balance > 6000 AND cashFlow > 200
per month then
recommend mortgages tagged MED ACCT BAL AND POSITIVE

CASH FLOW with confidence 0:4

end if

In an embodiment, the tag recommender 1304 uses the following list of exemplary table.

| Tag | Description |
|---|---|
| CONSERVATIVE | Target customers that are sensitive to risk. |
| AGGRESSIVE | Target customers that aren't sensitive to risk. |
| MED_ACCT_BAL | Targets customers with normal account balances. |
| HIGH_ACCT_BAL | Targets customers with high account balances. |
| AGE_UNDER_30 | Targets customers under 30. |
| AGE_OVER_30 | Targets customers 30 or over. |
| EVEN_CASH_FLOW | Targets customers whose income matches their expenses. |
| POSITIVE_CASH_FLOW | Targets customers whose income is greater than their expenses. |
| SAVING_FOR_HOUSE | Targets customers whose accounts indicate they are saving for a home. |
| De_25_a_34 | Target customers from 25 to 34. |
| De_35_a_44 | Target customers from 35 to 44. |
| De_45_a_54 | Target customers from 45 to 54. |
| De_55_a_64 | Target customers from 55 to 64. |
| Ms_de_65 | Target customers 65 or over. |

In an embodiment, the tag recommender 1304 can use other tables including tables listing tags for labeling financial products, tables where the tags are actually assigned to the financial products, and tables containing actual financial products of a particular financial institution.

The product and tag recommenders 1302 and 1304, respectively, produce a set of scores over financial products. The recommender engine 802 combines these scores before providing the combined scores to the recommendation system 800 or the user, as appropriate or necessary. In an embodiment, the recommender engine 802 combines the scores by taking a weighted average of the two scores for each product. The weighting can be set in one or more configuration files, along with other configuration properties. In a default embodiment, the weighting skews heavily toward the product recommender 1302.

In an embodiment, the final scores are sent to a user in the form of recommendations. In other embodiments, the recommendations and their preceding final scores are passed through a series of filters for example, to remove the financial products that the user has explicitly down rated (or otherwise indicated adversely) in the past. In an embodiment, the recommender 802 may also filter recommendations to encourage diversity of financial product holdings (i.e., avoid recommending further credit card products if a user already owns and uses more than a predetermined amount of credit cards or has a certain level of credit card debt). In an embodiment, the recommender engine 802 can further filter recommendations according to recent recommendation history.

It will be obvious to those having skill in the art that they may make many changes to the details of the above-described embodiments without departing from the underlying principles of the present description. The scope of the present description, therefore, is to be determined only by the following claims.

1. A method comprising:
fetching financial product data from one or more financial institutions;
retrieving user information from one or more databases configured to store the user information;
retrieving user financial information from one or more databases configured to store the user financial information;
determining user feedback by analyzing the user financial information;
recommending one or more vendors or one or more financial products in response to at least a portion of the product data, user information, user financial information, or user feedback, or combinations thereof.

2. The method of claim 1 wherein the fetching the financial product data includes fetching the financial product data associated with one or more certificates of deposit, investments, securities, stocks, savings accounts, checking accounts, or bonds.

3. The method of claim 1 wherein the fetching the financial product data includes fetching financial product data associated with currently offered financial products and financial products offered in a past.

4. The method of claim 1 wherein the fetching the financial product data includes automatically scrapping the financial product data from online sources.

5. The method of claim 1 wherein the fetching the financial product data includes automatically scrapping the financial product data from online searches.

6. The method of claim 1 wherein the fetching the financial product data includes automatically scrapping the financial product data from a customer relationship management site associated with the one or more financial institutions.

7. The method of claim 1 wherein the fetching the financial product data includes fetching the financial product data from one or more sponsor financial institutions.

8. The method of claim 1 wherein the fetching the financial product data includes storing the financial product data from the one or more financial institutions in one or more databases configured to store the financial product data.

9. The method of claim 1 wherein the retrieving the user information includes retrieving the user information explicitly provided by a user via a graphical interface.

10. The method of claim 1 wherein the retrieving the user information includes retrieving one or more of demographic, marital status, geographic, asset, profession, recreational interests, offspring, or family user information.

11. The method of claim 1 wherein the retrieving the user information includes retrieving the user information implicitly without user intervention by analyzing the user financial information.

12. The method of claim 11 wherein the retrieving the user information implicitly without user intervention by analyzing the user financial information includes determining one or more correlations between one or more aspects of the user financial information.

13. The method of claim 1 wherein the determining the user feedback includes determining the user feedback explicitly provided by a user via a graphical interface.

14. The method of claim 13 wherein the determining the user feedback explicitly includes retrieving one or more of binary or rating usefulness indicators provided by a user.

15. The method of claim 1 wherein the determining the user feedback includes determining the user feedback implicitly without user intervention by analyzing the user financial information.

16. The method of claim 15 wherein the retrieving the user feedback implicitly without user intervention occurs responsive to user conduct associated with the recommended one or more vendors or the one or more financial products.

17. The method of claim 16 wherein the retrieving the user feedback implicitly without user intervention occurs responsive to delayed user conduct associated with the recommended one or more vendors or the one or more financial products.

18. The method of claim 16 wherein the retrieving the user feedback implicitly without user intervention occurs responsive to immediate user conduct associated with the recommended one or more vendors or the one or more financial products.

19. The method of claim 16 wherein the retrieving the user feedback implicitly without user intervention includes assigning a weighing factor to the user conduct associated with the recommended one or more vendors or the one or more financial products.

20. The method of claim 19 wherein the assigning a weighing factor to the user conduct includes assigning a weighing factor that decays over time.

21. The method of claim 1 further comprising fetching tip data from the one or more financial institutions.

22. The method of claim 21 wherein the fetching the tip data includes fetching one or more editorial tips.

23. The method of claim 21 wherein the fetching the tip data includes fetching one or more community tips.

24. The method of claim 23 wherein the fetching the one or more community tips includes filtering the one or more community tips.

25. The method of claim 21 wherein the fetching the tip data includes storing the tip data in one or more databases configured to store tip data.

26. An apparatus, comprising:
means for fetching financial product data from one or more financial institutions;
means for retrieving user information from one or more databases configured to store the user information;
means for retrieving user financial information from one or more databases configured to store the user financial information;
means for determining user feedback by analyzing the user financial information;
means for recommending one or more vendors or one or more financial products in response to at least a portion of the product data, user information, user financial information, or user feedback.

27. The apparatus of claim 26 wherein the financial product data includes one or more certificates of deposit, investments, securities, stocks, savings accounts, checking accounts, or bonds.

28. The apparatus of claim 26 wherein the means for fetching the financial product data includes means for fetching financial product data associated with currently offered financial products and financial products offered in a past.

29. The apparatus of claim 26 wherein the means for fetching the financial product data includes means for automatically scrapping the financial product data from online sources.

30. The apparatus of claim 26 wherein the means for fetching the financial product data includes means for automatically scrapping the financial product data from online searches.

31. The apparatus of claim 26 wherein the means for fetching the financial product data includes means for automatically scrapping the financial product data from a user relationship management site associated with the one or more financial institutions.

32. The apparatus of claim 26 wherein the means for fetching the financial product data includes means for fetching the financial product data from one or more sponsor financial institutions.

33. The apparatus of claim 26 wherein the means for fetching the financial product data includes means for storing the financial product data from the one or more financial institutions in one or more databases configured to store the financial product data.

34. The apparatus of claim 26 wherein the means for retrieving the user information includes means for retrieving the user information explicitly provided by a user via a graphical interface.

35. The apparatus of claim 26 wherein the user information includes one or more of demographic, marital status, geographic, asset, profession, recreational interests, offspring, or family user information.

36. The apparatus of claim 26 wherein the means for retrieving the user information includes means for retrieving the user information implicitly without user intervention by analyzing the user financial information.

37. The apparatus of claim 36 wherein the means for retrieving the user information implicitly without user intervention includes means for determining one or more correlations between one or more aspects of the user financial information.

38. The apparatus of claim 26 wherein the means for determining the user feedback includes means for determining the user feedback explicitly provided by a user via a graphical interface.

39. The apparatus of claim 38 wherein the means for determining the user feedback explicitly includes means for retrieving one or more of binary or rating usefulness indicators provided by a user.

40. The apparatus of claim 26 wherein the means for determining the user feedback includes means for determining the user feedback implicitly without user intervention by analyzing the user financial information.

41. The apparatus of claim 40 wherein the means for retrieving the user feedback implicitly without user intervention occurs responsive to user conduct associated with the recommended one or more vendors or the one or more financial products.

42. The apparatus of claim 40 wherein the means for retrieving the user feedback implicitly without user intervention occurs responsive to delayed user conduct associated with the recommended one or more vendors or the one or more financial products.

43. The apparatus of claim 40 wherein the means for retrieving the user feedback implicitly without user intervention occurs responsive to immediate user conduct associated with the recommended one or more vendors or the one or more financial products.

44. The apparatus of claim 40 wherein the means for retrieving the user feedback implicitly without user intervention includes means for assigning a weighing factor to the user conduct associated with the recommended one or more vendors or the one or more financial products.

45. The apparatus of claim 44 wherein the means for assigning a weighing factor to the user conduct includes means for assigning a weighing factor that decays over time.

46. The apparatus of claim 26 further comprising means for fetching tip data from the one or more financial institutions.

47. The apparatus of claim 46 wherein the means for fetching the tip data includes means for fetching one or more editorial tips.

48. The apparatus of claim 46 wherein the means for fetching the tip data includes fetching one or more community tips.

49. The apparatus of claim 48 wherein the means for fetching the one or more community tips includes means for filtering the one or more community tips.

50. The apparatus of claim 46 wherein the means for fetching the tip data includes means for storing the tip data in one or more databases configured to store tip data.

51. A system, comprising:
one or more databases each configured to store at least a portion of financial product data associated with one or more financial products, at least a portion of personal information, personal financial information, or personal feedback associated with one or more users, or at least a portion of one or more correlations between the financial product data, or personal information, personal financial information, or personal feedback of the one or more users;
one or more worker computing devices each configured to execute instructions stored in the one or more databases associated with:
a fetching module configured to fetch, from one or more financial institutions, the financial product data associated with the one or more financial products or the personal financial information associated with the one or more users;
a correlating module configured to determine the one or more correlations to identify one or more clusters of users; and
a recommending module configured to recommend one or more vendors or one or more financial products in response to at least one of the one or more correlations between the one or more users or the one or more of the clusters of users.

52. The system of claim 51 wherein the one or more financial products include at least one of certificates of deposit, investments, securities, stocks, savings accounts, checking accounts, or bonds.

53. The system of claim 51 wherein the fetching module is further configured to fetch financial product data associated with currently offered financial products and associated with financial products offered in a past.

54. The system of claim 51 wherein the fetching module is further configured to automatically scrape the financial product data from online sources or searches.

55. The system of claim 51 wherein the fetching module is further configured to automatically scrape the financial product data from a user relationship management website associated with the one or more financial institutions.

56. The system of claim 51 wherein the fetching module is further configured to fetch the financial product data from one or more sponsor financial institutions.

57. The system of claim 51 wherein the fetching module is further configured to retrieve the personal financial information associated with the one or more financial products or one or more financial transactions.

58. The system of claim 51 wherein the fetching module is further configured to retrieve the personal financial information associated with one or more loans, credit cards, insurance policies, stocks, certificates of deposits, mortgages, or lines of credit.

59. The system of claim 51 wherein the correlating module is configured to determine correlations between each of the one or more users and each of the one or more clusters of users.

60. The system of claim 59 wherein each correlation includes at least one pair of numbers with a recommended item and an associated value representing a strength of the recommended item.

61. The system of claim 59 wherein the correlating module is configured to generate a vector space model including a vector for the financial product data associated with each of the one or more financial products, a vector for each of the personal information, personal financial information, or personal feedback associated with each of the one or more users, or a vector for each of the correlations.

62. The system of claim 59 wherein the one or more worker computing devices are each configured to executed instructions store in the one or more databases associated with a user interface.

63. The system of claim 62 wherein the user interface is configured to provide a graphical mechanism for a user to explicitly enter the personal information or the personal feedback.
